(19) United States
(12) Patent Application Publication
(10) Pub. No.: US 2019/0130780 A1
(43) Pub. Date: May 2, 2019

(54) GENERATIVE LANGUAGE TRAINING USING ELECTRONIC DISPLAY

(71) Applicant: Purdue Research Foundation, West Lafayette, IN (US)

(72) Inventor: Oliver Wendt, West Lafayette, IN (US)

(21) Appl. No.: 16/225,752

(22) Filed: Dec. 19, 2018

Related U.S. Application Data
(62) Division of application No. 14/280,047, filed on May 16, 2014, now abandoned.
(60) Provisional application No. 61/824,396, filed on May 17, 2013.

(51) Int. Cl. G09B 7/06

(52) U.S. Cl. CPC G09B 7/06

(57) ABSTRACT

Methods of conducting generative language training using a training corpus having a plurality of words and a plurality of stimuli are described. A stimulus is presented via an electronic display. A selection is received from visual representations of a plurality of the words represented on the display. It is determined whether the selected words correspond to the represented words in the stimulus. A mastery level can be determined based on correspondence of the responses and stimuli and the training corpus or sequence modified based on the mastery level. Another method includes receiving mastery-level data for multiple learners and determining a training sequence using relative difficulties determined from the mastery-level data. Another method includes determining a proficiency level using the correspondence of responses and, if the determined proficiency level corresponds to an intervention criterion, performing an intervention sequence including detecting word selections and unlocking inputs.

### CROSS-REFERENCE TO RELATED APPLICATIONS

This application is a divisional of U.S. patent application Ser. No. 14/280,047, filed May 16, 2014, and entitled “Generative Language Training Using Electronic Display”, which is a nonprovisional of, and claims priority to and the benefit of, U.S. Patent Application Ser. No. 61/824,396, filed May 17, 2013, and entitled “Method and System for Matrix Training to Teach Graphic Symbol Combinations in Severe Autism,” the entirety of each of which is incorporated herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present application relates to methods and system for facilitating training of individuals with developmental disorders.

### BACKGROUND

Individuals with autism (also known as autism spectrum disorders, ASD) or other developmental speech and language disorders (e.g., Down Syndrome, Fragile X Syndrome, or Intellectual Impairment) can be taught to recognize and use individual graphic symbols for basic functional communication purposes such as requesting, labeling, or rejecting. However, while such individuals may point to an icon of a cookie when hungry, they generally do not use symbols in combination (e.g., pointing to a symbol for “give” and another for “cookie” to indicate “give me a cookie”). Difficulty in combining symbols greatly restricts the range of ideas such people can communicate. At least partly in recognition of this, finding effective interventions for nonverbal students with severe autism has been established as a priority within the National Institutes of Health (National Institute on Deafness and Other Communication Disorders, 2010). There is, therefore, a need for a way of training individuals with severe communication disorders (“learners” or “patients”) to use symbols in combination.

Specifically, about 50% of individuals with autism have severe speech and language disorders to an extent that they cannot meet their daily communication needs. These individuals are candidates for Augmentative and Alternative Communication (AAC) intervention. AAC is defined as the supplementation or replacement of natural speech and/or writing through alternative means of communication such as electronic communication devices, gestures, or graphic symbols (Lloyd, Fuller, & Arvidson, 1997). AAC augments or replaces spoken language through alternative means such as graphic symbols or electronic devices. An AAC strategy that has recently become increasingly popular in the autism community is the use of IPADs and other tablet devices, including speech-generating devices (SGDs) for communication purposes. An exemplary SGD is the IPAD running the SPEAKall!™ app. Exemplary uses of tablets include teaching requesting skills (Achmadi et al., 2012) and picture labeling (Kagohara et al., 2012). AAC users with autism have been able to learn graphic symbols primarily for requesting, labeling, and rejecting. Their utterances, however, remained at the single-symbol stage, and they do not learn how to combine graphic symbols into meaningful combinations to elaborate their meaning. Moving from single- to multiple-symbol utterances and generalizing those productions is a critical step towards the emergence of syntax and generative language. There is, therefore, a need for ways of teaching multiple-symbol utterances to this population.

A technique known as “matrix training” (Nigam et al., 2006) teaches pairs of symbols from a vocabulary the learner already knows. Matrix training is an intervention to facilitate generative language, that is, the combination of single symbols into generalized multiple-symbol utterances to create new meaning. Matrix strategies use linguistic elements (e.g., nouns, verbs, etc.) presented in systematic combination matrices, which are arranged to induce generalized rule-like behavior. The clinician models combining a limited set of words in one semantic category with another set in a related semantic category to facilitate the child's acquisition of generalized combining of lexical items (Nelson, 1993). In an example, the learner is exposed to a stimulus and then has to select two or more symbols relevant to that stimulus out of a vocabulary of symbols. Matrix training teaches certain pairs (e.g., “eat” and “cookie”; “throw” and “ball”) and then tests whether the learner can generalize (e.g., to “throw” and “cookie”).

Specifically with regard to pediatric language acquisition, children without disabilities demonstrate a core lexicon of 40-50 words by 18 months and begin to create word combinations. This milestone marks the emergence of syntax and the onset of generative language (Paul, 1997). Brown and Leonhard (1986) found that words in a positional productive pattern (marked by word combinations such as action+object, e.g., eat cookie) are among the first word combinations to emerge in child language. AAC users with autism struggle to follow this developmental trajectory. Nevertheless, once an individual has acquired single-word utterances and masters an initial communication repertoire with or without speech, it is important to make the transition from single to multiple word utterances to produce two-term, three-term and so forth semantic relationships (e.g., such as action+object, agent+action, possessor+possession, agent+action+object, etc). One particular intervention strategy to teach multiple-symbol combinations is the matrix training.

For example, a 2×2 matrix can be designed with two colors on one axis and two objects on the other axis, allowing four different color-object combinations. If two of the four combinations are taught, the learner may be able to generalize the skill to the untaught combinations. For example, if a child is taught to label “yellow apple” and “red pear”, the combinations “yellow pear” and “red apple” may emerge without direct instruction. Goldstein (1983) described this process as recombinative generalization, defined as the “differential responding to novel combinations of stimulus components that have been included previously in other stimulus contexts” (p. 281). Recombinative generalization emerges when the language learner is able to discriminate relations between symbols and referents and to induce a symbol order rule to construct novel combinations of symbols from two or more semantic classes. Recombinative generalization helps language learners comprehend and express untrained utterances.

Several studies demonstrated recombinative generalization effects in verbal individuals with intellectual impairment. Matrix training was used to teach combinations of action-object (Mineo & Goldstein, 1990), object-location or preposition-object (Ezell & Goldstein, 1989), and descriptor (color)-object (Remington, Watson, & Light, 1990). Goldstein, Angelo, and Mousetis (1987) taught labeling and instruction following a matrix approach using both known and unknown words. Results indicated that teaching one combination with previously unknown words produced correct responding to the remaining unknown word combinations. Goldstein et al. reported that 94-98% of the learning was untrained. Related to nonverbal individuals with intellectual impairment, Nigam, Schlosser, and Lloyd (2006) were able to show that matrix training plus mand-model procedures can be used to teach action-object, graphic symbol combinations on a simple communication board.

Kinney, Vedora, and Stromer (2003) targeted generative spelling using video modeling with a first-grade student on the autism spectrum. The learner mastered to spell subsets of four three-by-three matrices, then immediately showed mastery of spelling the remaining words in each matrix. Dauphin, Kinney, and Stromer (2004) combined matrix training with video-based activity schedules to teach socio-dramatic play to a 3-year-old boy on the autism spectrum. A 3×3 instructional matrix introduced 9 activities to be performed including combinations of 3 agents and 3 actions. For every agent-action relation taught directly, nearly 2 additional untrained combinations also occurred. Axe and Sainato (2006) taught four preschoolers on the autism spectrum to follow instructions arranged in action-picture combination matrices; for two learners untrained responding appeared after the minimum amount of training, while the other two needed further training to produce untrained combinations.

However, matrix training requires extensive and meticulous recordkeeping, making it difficult to implement on a large scale. Moreover, the range of stimuli that can be presented on, e.g., paper-based communication boards is very limited. There is, therefore, a need for a way of conducting matrix training that can use a wider range of stimuli to teach a wider range of ideas. There is also a need of systems that permit therapists, clinicians, Board Certified Behavior Analysts (BCBAs), parents, teachers, or others assisting in the training process (collectively, “interventionists”) to assist learners according to the individual needs of those learners.

### BRIEF DESCRIPTION

According to an aspect, there is provided a method of conducting generative language training using a training corpus having a plurality of words and a plurality of stimuli, the method comprising automatically performing the following steps using a processor:

determining a stimulus by selecting one of the stimuli according to a selected training sequence;

presenting the stimulus via an electronic display, the stimulus representing multiple ones of the words;

presenting visual representations of a plurality of the words via the display, wherein each word is included in at least one of a plurality of categories and the presenting includes presenting the respective visual representations of one word included in a first one of the categories and one different word included in a second, different one of the categories;

receiving a selection of a plurality of the presented words via an input device;

determining whether the selected words correspond to the represented words in the stimulus and recording an indication of the result of the determination; and

repeating the presenting-stimulus through determining-and-recording steps for each of one or more of the stimuli according to the training sequence.

According to another aspect, there is provided a method of conducting generative language training, the method comprising automatically performing the following steps using a processor:

receiving respective mastery-level data for each of a plurality of learners and each of a plurality of groups of words, the respective mastery-level data indicating correspondence of selections from those words by that learner with stimuli presented via an electronic display;

using the processor, automatically determining a respective relative difficulty level for each of the groups of words using the corresponding mastery-level data; and

determining a training sequence for the groups of words based on the determined relative difficulty levels.

According to yet another aspect, there is provided a method of conducting generative language training using a training corpus having a plurality of words and a plurality of stimuli, the method comprising automatically performing the following steps using a processor:

performing an evaluation sequence one or more time(s) to determine respective indication(s), the evaluation sequence including:
presenting a stimulus via an electronic display, the stimulus representing multiple ones of the words;
presenting visual representations of a plurality of the words via the display, wherein each word is included in at least one of a plurality of categories and the presenting includes presenting the respective visual representations of one word included in a first one of the categories and one different word included in a second, different one of the categories;
receiving a selection of a plurality of the presented words via an input device;
determining whether the selected words correspond to the represented words in the stimulus and recording the respective indication of the result of the determination;

determining a proficiency level using the respective indication(s);

if the determined proficiency level corresponds to an intervention criterion, performing an intervention sequence including:
receiving an input;
if the input corresponds to one of the visual representations, presenting a response via the electronic display or an output device, and returning to the receiving-input step; and
if the input corresponds to an unlocking input, presenting a second, different stimulus via the electronic display.

Various embodiments advantageously provide matrix training for language acquisition using an electronic device. Various embodiments advantageously adapt the course of training to each learner or group of learners. Various embodiments advantageously facilitate interaction not only between the learner and the electronic device, but also between the learner, the interventionist, and the electronic device.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIGS. 1-5 and 6A-6C are flowcharts of methods of conducting generative language training according to various aspects;

FIGS. 7-10 are graphical representations of exemplary screen displays useful for generative language training according to various aspects;

FIG. 11 is a depiction of a learner interacting with a tablet according to various aspects;

FIG. 12 is a graphical representation of a feedback screen display according to various aspects;

FIGS. 13 and 14 are graphical representations of exemplary screen displays useful for pre-qualification of words to be used in generative language training according to various aspects; and

FIG. 15 is a high-level diagram showing components of a data-processing system and associated components.

The attached drawings are for purposes of illustration and are not necessarily to scale.

### DETAILED DESCRIPTION

Throughout this disclosure, examples are given in American English. However, training can be performed in other languages, e.g., German, or other dialects, e.g., British English.

Throughout this description, some aspects are described in terms that would ordinarily be implemented as software programs. Those skilled in the art will readily recognize that the equivalent of such software can also be constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

Prior schemes do not describe ways of facilitating the acquisition and generalized production of graphic symbol combinations via matrix training in, e.g., nonverbal children with autism who are using an IPAD or other speech-generating device (SGD). Accordingly, there is a need for ways of enabling this training and overcoming the known limitations of matrix training. Prior schemes do not use IPADs or other electronic devices and thus and do not describe or suggest inventive herein-described ways of training using such devices.

The acquisition and generalized production of graphic symbol combinations in non-verbal children with autism who are using augmentative and alternative communication (AAC) is disclosed. Various aspects apply a multiple probe (trial) design to assess learning and generalization of action-object combinations in learners with nonverbal autism who receive matrix training through an innovative tablet (e.g., IPAD) app.

Various embodiments use the matrix-training strategy to train production of action-object graphic symbol combinations on an SGD.

Various aspects encourage learners to generalize newly learned skills in producing multiple-word combinations to untrained combinations. Effectiveness of such generalization can be measured by taking generalization trials during the intervention phase, assessing performance on combinations that were never taught before.

Various aspects encourage learners to generalize newly learned skills across trainers and contexts (e.g., as generalization is a particular deficit in autism). Effectiveness of such generalization can be measured by having a different interventionist (e.g., behavior analyst or speech-language pathologist) conduct an intervention session in a different context (e.g., playground) at regular intervals (e.g., every other week) and taking generalization trials for these sessions.

According to various aspects, matrix training is implemented on a tablet, e.g., as an IPAD or ANDROID app. This is the first known use of an electronic device to conduct matrix training (a type of generative language training) of linguistic symbol combinations. The app handles recordkeeping automatically, and can provide motion stimuli (e.g., video clips or animated icons). This makes it useful for, e.g., training verb-noun combinations, because the video can show the verb (e.g., “drop”) and the noun (e.g., “cup”). The app can also present static stimuli, e.g., 2D still pictures. The app can also include a setup mode that permits the interventionist, clinician, or other person to configure matrices of stimuli and words for individual learners or groups of learners, and to update the training corpus of available words or stimuli.

Highly iconic graphic symbols on IPAD displays appeal to visual-spatial processing strengths in autism. IPADs are also lightweight and very portable, highly motivating to use, easy to program, and socially appealing (Flores et al., 2011). Furthermore, these tablet devices share the general, beneficial characteristics of SGDs. SGDs can have advantages over non-electronic systems because they provide additional auditory stimuli for the learner via speech output, which can facilitate receptive and expressive language development. It has been argued that additional provision of speech output presented as (a) antecedent auditory stimuli (a.k.a. “augmented input”), and/or (b) consequence auditory stimuli (a.k.a. “feedback”) may benefit learners with developmental disabilities. The inherent consistency of synthetic speech, combined with increased opportunities to hear it, contributed to gains in receptive and expressive language skills in adolescents with intellectual disabilities using SGDs (Romski & Sevcik, 1993, 1996). IPADs with communication apps (i.e., dedicated programs downloadable from the iTunes store) can provide exactly these advantages.

Learners for whom techniques described herein can be useful include those who meet the following criteria: (1) an official diagnosis of autistic disorder according to the DSM-IV-TR (American Psychiatric Association, 2000), (2) late elementary to middle school-age range (i.e., 8-16 yrs.), (3) little or no functional speech operationalized as no more than 5-10 spoken words, (4) visual and auditory processing within normal levels, (5) adequate hand coordination for graphic symbol pointing on an IPAD, (6) understanding simple verbal commands (e.g., “Sit down”) and responding to yes-no questions, (7) experience using IPADs or other SGDs with graphic symbols, but no experience using graphic symbol combinations, and (8) no previous exposure to matrix-training.

Various embodiments include (a) within-learner replication of the intervention across behaviors (action-object combinations) at different points in time; and (b) between-learner replication of the intervention. Materials for various aspects include 6 action words (e.g., take, push, etc.) and 6 object words (e.g., ball, toy, etc.) put into a matrix format (see Table 1, below). Action and object words, or other words, can be represented in Picture Communication Symbols (PCS), which are known to be highly iconic and easy to learn because they closely resemble their referents (Lloyd & Fuller, 1990). These symbols can be displayed on the main screen of an IPAD or other table that functions as an SGD. Training sessions using generative language training as described herein can be conducted, e.g., at least 3 days a week for about 30 minutes each.

Communicative competence for a nonverbal person who relies on AAC requires linguistic, operational, social, and strategic competencies (Light, 1989). AAC investigations in the past (for individuals with autism as well as other developmental disabilities) have primarily concentrated on establishing functional communication and improving pragmatic skills (Binger & Light, 2007). Various aspects herein permit development of linguistic competence. Nonverbal individuals with autism struggle to communicate effectively. Once the individual has acquired single-symbol utterances and is expressing some basic communicative functions, it is useful to make the transition from single- to multiple symbol utterances to form two-term, three-term and further semantic relationships and eventually be able to communicate longer sentences. For people using AAC who have achieved some linguistic competence through single-symbols, using multiple symbols for expressive communication skills can greatly enhance the content, function, and power of their messages (Wilkinson, Romski, & Sevcik, 1994). The implementation of a matrix training approach in clinical AAC practice as described herein can make a valuable contribution in this direction.

In addition to linguistic competence, matrix training addresses another important area of clinical concern in nonverbal autism, namely generalization of newly learned information (Froehlich et al., 2012). Generalization can be behaviorally defined as the “occurrence of relevant behaviour under different non-training conditions” (Stokes & Baer, 1977, p. 350). In other words, generalization means applying learning in one context to different contexts. Matrix training intervention for autism according to various aspects helps to target generalization deficits in more depth. Matrix training in general aims to enhance recombinative generalization, which has been defined as the demonstration of novel arrangements of previously established stimuli (Suchowierska, 2006). Recombinative generalization allows an individual to engage in generative responding, which refers to producing behaviors that have not been previously demonstrated and have not been directly trained, but may originate from previously trained responses (Schumaker & Sherman, 1970). In terms of language learning, generative responding means comprehending questions, requests, and comments (receptively) that the learner has not heard before, and producing utterances (expressively) that have not been created before. Both skills are vital in the development of flexible and functional, not stereotypical and rote, language (Suchowierska, 2006). Matrix training is not limited to teaching language. Accordingly, the techniques and systems described herein can be used to teach generalization in a wide variety of skills (e.g., emergent literacy, play, social skills). Clinicians and teachers who work with individuals on the autism spectrum often have many skills they need to target. They may be able to provide better instruction when arranging teaching targets in matrices to promote efficient teaching.

Moreover, given the importance of generative responding, it is useful for researchers to better understand its underlying process of recombinative generalization. When familiar stimuli are recombined in novel ways and stimulus elements continue to apply precise and proper control over corresponding portions of the response, recombinative generalization has emerged (Wetherby & Striefel, 1978). Although research on recombinative generalization started over 80 years ago (the very first experiment was conducted by the early psycholinguist Irwin Esper in 1925), understanding of this process is still not fully complete, particularly for learners with developmental disabilities such as severe autism. One condition that has been shown to result in generalized responding is conditional discrimination, which means responding to one stimulus is reinforced contingent on an additional (conditional) stimulus (Saunders & Williams, 1998). To be able to produce recombinative multiple-term phrases (e.g., drop ball, wipe car), the learner must acquire multiple-term conditional discrimination. In the given example, the conditional discrimination would be two-term (action-object). Conditional discrimination becomes possible when during instruction of “drop ball” and “wipe car”, distracters for both terms (action and object) are present (i.e., drop ball, wipe car, wipe ball, drop car). The response now becomes conditional depending on what action is performed with the object. In other words, the action “drop” defines what is done with the object and becomes a conditional stimulus. A correct conditional discrimination is only performed when both terms at the same time are discriminated to generate one correct response. Peterson and colleagues (2003) have demonstrated that learners via matrix training can achieve discrimination of two-term (e.g., subject-action), three-term (e.g., action-adjective-object), four-term (e.g., subject-preposition-adjective-objective), and five-term (e.g., subject-action-preposition-adjective-object) relations. According to various aspects, these correspond respectively to 2-D, 3-D, 4-D, and 5-D matrices. Various aspects herein permit training two-term (action-object) relations, three-term, four-term relations, or other term counts.

Recombinative generalization is very useful in the acquisition of a conventional language system (Goldstein, 1985; Suchowierska, 2006). Methods and system described herein can permit researchers and clinicians to learn more about this process for learners with severe autism. For a behaviorally oriented researcher, a learner's correct identification of untrained symbols (in an expressive or receptive task) is an indicator that this learner's responding is under the control of small units that were not presented independently, but rather developed from larger units (Skinner, 1957). For a clinician, the same performance shows that this learner does not always need to be taught responding to every single novel stimulus, but rather that generative responding might develop. Various aspects herein permit teaching in a manner that facilitates recombinative generalization and can be used to provide research data to broaden understanding of basic learning processes and their applicability to teaching language and other critical skills to learners with severe autism.

Compared to other populations on the autism spectrum, nonverbal autism is studied much less and often poorly understood. A workshop at the National Institutes of Health (NIH) revealed “that almost no research focuses on this group” (Tager-Flusberg, 2010, p. 6). The workshop pointed out a need to design novel interventions for nonverbal autism, particularly in the area of language and communication. Similarly, the most recent strategic plan of the Interagency Autism Coordinating Committee (2011) calls for “additional research on the use of alternative and augmentative communication (AAC) to facilitate communication for nonverbal individuals with ASD”. The same proposition is made by the Autism Speaks Foundation (2012), who recently held three meetings on nonverbal autism. Again, these meetings revealed a lack of knowledge about this population and ways to address their communicative development.

Nonverbal individuals with autism comprise up to 25% of the autism spectrum, and the community of clinical researchers knows very little about effective interventions. It seems clear that these individuals learn language and communication with great difficulty as compared to their peers with milder forms of ASD or without disabilities. One of the primary goals of communication intervention in developmental disabilities is to help individuals successfully participate in communicative interactions. Some initial efforts have been documented that AAC systems can help accomplish this goal in nonverbal autism; the focus of these efforts has been on teaching individuals to exercise some control over their environment, namely by requesting desired objects (e.g., foods, toys) and activities (e.g., play, toilet). AAC approaches have shown great utility in establishing such initial communication repertoires. However, investigators have made little progress in moving clients from these initial repertoires to more conventional language systems that can be used to convey multiple communication functions (e.g., commenting, labeling, not only requesting). Clinicians often report that implemented AAC strategies are not used spontaneously and remain prompt-dependent. If the student only has a limited repertoire of communicative acts available, spontaneous communication and language are unlikely to emerge. Various aspects herein provide a systematic instructional approach that assist clinicians to enable nonverbal individuals with autism to make use of the communicative potential inherent in AAC systems. Various aspects not only target the acquisition of single symbols and one-symbol utterances, but also teach the generative use of an initial symbol repertoire.

There is currently a desire to provide nonverbal children with tablet devices and communication apps. However, graphic-symbol-based interventions do not “teach themselves”, that is, merely exposing the individual to specific materials does not automatically result in behavior change. As Mirenda (2009) points out, the success or failure of an (AAC or other) intervention, “is not simply a matter of choosing symbols or devices; instructional variables are also critically important. Indeed, when AAC fails to result in functional communication, this failure usually reflects limitations in the procedures and methods used for instruction rather than an inherent problem with AAC itself” (p. 16). Various aspects herein permit instruction that helps nonverbal individuals with autism to improve their communication skills, thus addressing a very current and important challenge in the autism field.

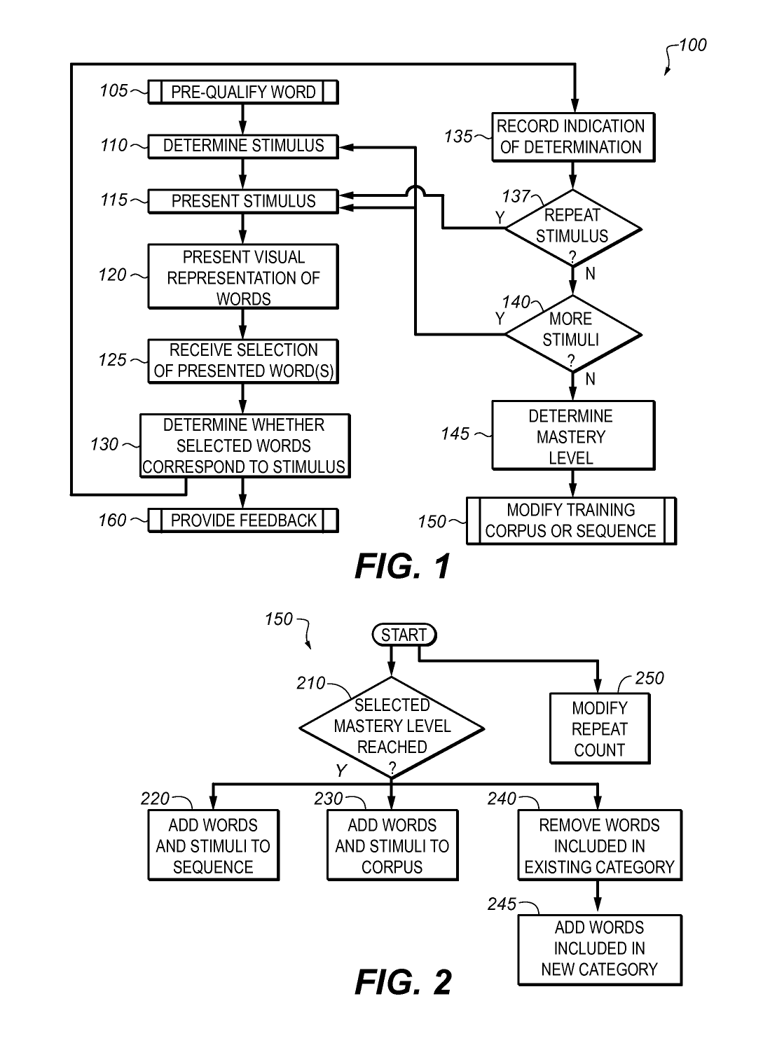

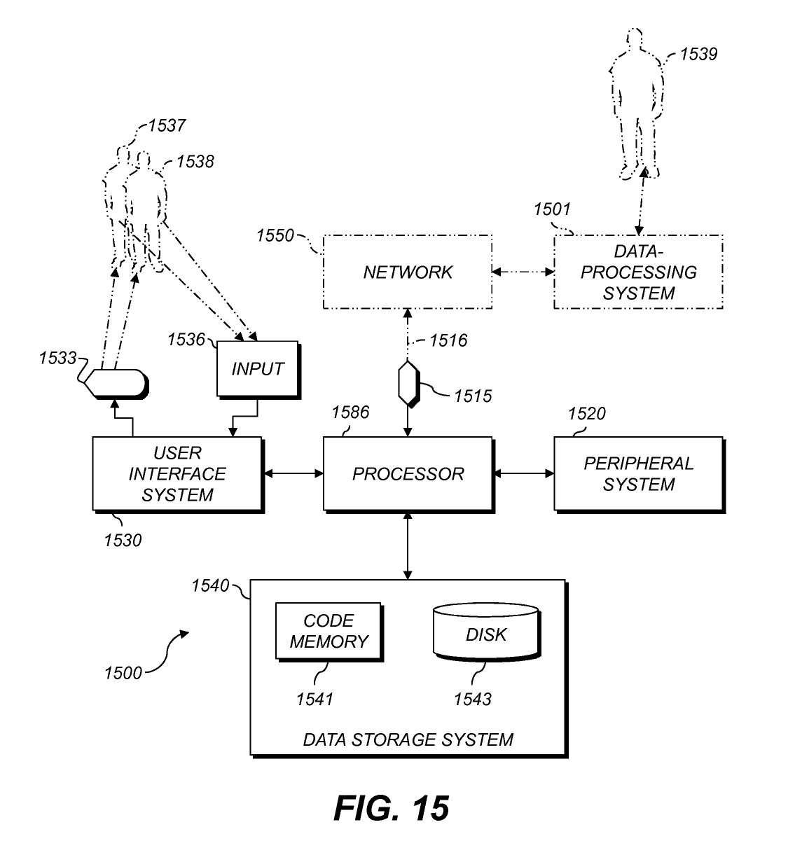

FIG. 1 is a flowchart illustrating exemplary methods for conducting generative language training. Generative language training, including matrix training, can advantageously facilitate improving the learner's ability to produce complex utterances. The steps can be performed in any order except when otherwise specified, or when data from an earlier step is used in a later step. In various examples, processing begins with step 105 or step 110. For clarity of explanation, reference is herein made to various components shown in FIGS. 11 and 15 that can carry out or participate in the steps of the exemplary method. It should be noted, however, that other components can be used; that is, exemplary method(s) shown in FIG. 1 are not limited to being carried out by the identified components. Methods can include performing the following steps using a processor 1586 or other data processing system 1500, 1501 (all FIG. 15).

The training is conducted using a training corpus having a plurality of words and a plurality of stimuli. The training corpus can include some words currently being tested and some words that are not yet being tested. The training corpus can be represented as a matrix or tensor having a category associated with each dimension and a hyperplane corresponding to each value of each category. Each cell of the matrix thus corresponds to a unique selection of one element from each of the categories. For example, if three categories are chosen, the training corpus could be viewed as a 3-D cube, and if four categories are chosen, as a 4-D hypercube. This shape is not necessarily bounded by a hyperrectangle depending on how categories are selected for training purposes. For example, advanced students may be tested with words within the matrix or tensor but outside of a hyperrectangle currently under test.

Systems according to various aspects can be used in classrooms and clinical settings (e.g., autism treatment centers). Action symbols and object symbols (e.g., six of each) that are a match with the instructional and play activities in the setting can be used. In various aspects, e.g., the field of autism intervention, words are selected with reference to a learner's individual Verbal Behavior Milestones Assessment and Placement Program (VBMAPP) records. VBMAPP is a commonly used assessment tool and skill tracking system in autism centers. The learner's VBMAPP reveals what symbol repertoire is currently mastered and which symbols will be targeted in future instruction. In various aspects, words are selected with reference to symbols currently used by the learner on an existing SGD or IPAD. Symbols or words for the matrix training can be in the learner's existing repertoires, or not. Symbols and target combinations can be selected with reference to what would result in the most functional outcome for the learner.

In addition to the action symbols and object symbols (or symbols of other categories), corresponding stimuli are prepared: a digital photo or graphical representation of each object, a video clip of each action, and a video clip for each combination of an action and an object (36 videos for the 6×6 example in Table 1), illustrating performing the respective action with the respective object. In various aspects, all actions and objects will be combinable with each other. (In other aspects, not all actions and objects are combinable; for example, the action “shake” and the object “building” can be left uncombined so as to avoid the need to film or depict a person shaking a building). The stimuli are action-object symbol combinations that will be used in baseline and generalization trials (also referred to as “phases”). Out of this pool of stimuli, less than all the action-object combinations (e.g., twelve in number, as shown in Table 1) will be taught sequentially in the intervention phase.

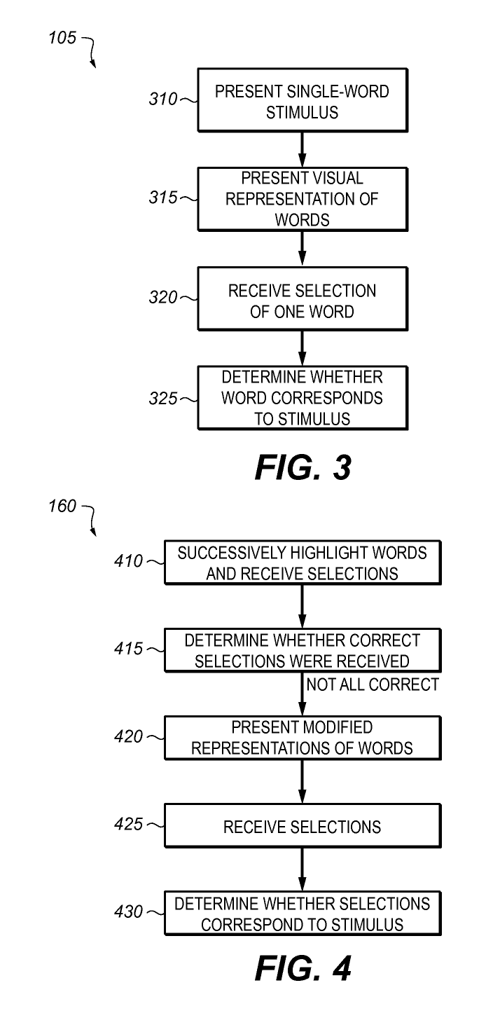

In step 105, before presenting a stimulus as described below with reference to step 115, a pre-assessment is performed. The pre-assessment is described below with reference to FIG. 3.

In step 110, a stimulus is determined by selecting one of the stimuli according to a selected training sequence. The training sequence specifies the order in which stimuli are presented to the learner. The training sequence does not have to be predetermined; random selections can be made. For example, the training sequence can specify a plurality of sets of stimuli and a number n of questions for each set. For each set, n random selections with replacement are made from the correspond stimuli, and the selected stimuli are presented sequentially to the learner.

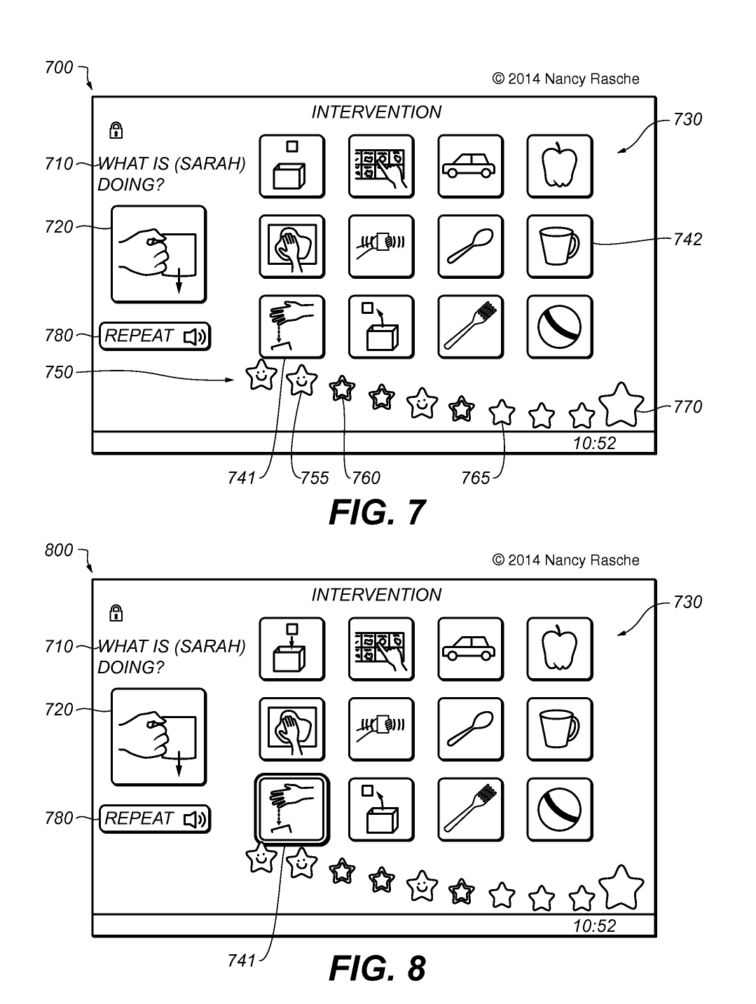

Steps 115, 120, 125, 130 correspond to a mand-model procedure that demands or requests a proper response from the learner (e.g., “Tell me by activating the symbol”), and provides the learner a proper model (e.g., Point to, “Ball”) if the child does not respond at all or gives an incomplete response (Rogers-Warren & Warren, 1980). The learner has three different response options in various aspects. First, if the learner responds by pointing to the correct action symbol (e.g., DROP) followed by the correct object symbol (e.g., CUP), positive feedback will be generated by the app (e.g., as discussed below with reference to happy-face icons 755, FIG. 7). Second, if there is no learner response, the system or the interventionist can provide a mand (“Tell me by activating the symbols”) followed by a time delay of, e.g., 4 s (e.g., as discussed below with reference to FIG. 6B). If the learner fails to respond to the mand, the interventionist can model the correct response on the device (e.g., as discussed below with reference to FIG. 6C) and ask the learner to imitate. Third, if the learner points to an incorrect symbol combination, the interventionist will provide a model of the correct response and then unlock the app to proceed to the next action-object combination to be taught (e.g., as discussed below with reference to lock icon 1099, FIG. 10).

Specifically, in step 115, the stimulus is presented, e.g., to a learner, via an electronic display. The stimulus represents multiple ones of the words, e.g., targeted word combinations to be taught. The electronic display can include a monitor, a television, or an electronic-tablet touchscreen. The stimulus can include a visual animation (“video”) such as an MPEG recording, an animated GIF, or a Flash cartoon. Animated stimuli convey motion in some way. Stimuli can also be non-video, e.g., text, still images, audio prompts.

In step 120, visual representations of a plurality of the words are presented via the display. Each word is included in at least one of a plurality of categories, e.g., as discussed below. The presenting includes presenting the respective visual representations of one word included in a first one of the categories and one different word included in a second, different one of the categories. In aspects using more than two categories, there are presented the visual representations of at least one respective word included in each of the different categories.

In various aspects, the first and second categories respectively include an adjective category and an object category, or a color category and an object category, or an object category and a location category, or an agent category and an action category. Other examples of categories include the following, denoted “A+B” for first category A and second category B (from Brown 1973; Bloom 1970, 1973): agent+action, action+object, agent+object, entity+attribute, possessor+possession, demonstrative+entity or predicate nominative (e.g., “there potty”), entity+locative, agent+locative, noun+locative, verb+locative, noticing+locative (e.g., “me here”), recurrence+object (e.g., “more cookie”), nonexistence+object (e.g., “allgone milk”), disappearance+object (“bye-bye car”), rejection+proposal (e.g., “no eat”), and denial+statement (e.g., “no wet”). Still other examples of categories include noun+verb, method of cooking+food product (e.g., “bake cookie”), and sports equipment+use thereof (e.g., “hit (with racquet) tennis ball”). Categories can be, e.g., semantic, interest-based, or chosen based on the targeted semantic roles (e.g., agent+action, action+object, agent+object). In general, categories separate classes of words that can be combined to create a meaning the individual words do not have by themselves. The order of the categories can be selected based on the word order of the language being trained. For example, the order adjective+noun can be used in English and German, and the order noun+adjective in French.

In step 125, a selection of a plurality of the presented words is received via an input device. The input device can include, e.g., a touch sensor arranged over the display in a touchscreen configuration; a mouse, joystick, trackball, or other pointing device; or a light pen.

In step 130, it is determined whether the selected words correspond to the represented words in the stimulus. In various aspects, step 130 includes determining whether the received selection includes exactly one word included in the first category and exactly one word included in the second category. Step 130 can be followed by step 135 or step 160.

In step 135, an indication of the result of the determination is recorded. The recording can be on a non-transitory (e.g., Flash) or transitory (e.g., RAM) computer-readable storage medium, and can be a permanent record or not. Step 135 can be followed by step 137, step 140, or step 145.

In step 137, if the shown stimulus is to be repeated according to the training sequence, the next step is step 115. Otherwise, the next step is step 137 or step 140. In this way, steps 115-135 are repeated) for this stimulus. The training sequence can be adjusted dynamically to move forward if the learner is not making progress.

In step 140, if another stimulus is to be tested according to the training sequence, the next step is step 110. In this way, steps 110, 115-135 are repeated) for each of one or more of the stimuli.

Table 1 shows an example of a training corpus and a training sequence for generative language training, specifically matrix training, of two categories: actions and objects:

Table 1 represents a 6×6 matrix including four training subsets (“Set 1” through “Set 4”), each including three action-object combinations, and 24 untrained combinations (outside Sets 1-4) referred to as “generalization items.” Set 1 includes “point to ball,” “point to cup,” and “drop cup.” Set 2 includes “drop spoon,” “take out spoon,” and “take out fork.” Set 3 includes “put in fork,” “put in apple,” and “shake apple.” Set 4 includes “shake car,” “wipe car,” and “wipe ball.” In various aspects, the words in the training corpus are pre-assessed as described herein to determine that the learner recognizes the actions and objects individually before combinations are tested. Although the numbers of actions and objects are equal in Table 1, that is not required. In general, the combinations of words or other items corresponding to a stimulus can be drawn from an m₀×m₁× . . . ×mₙ matrix for any number of categories n>1 and any number mₖ of elements in each category k ∈ 1 . . . n. The matrix can be sparse; it is not necessary to have completely filled categories at any level, and not all combinations are necessarily tested.

In Table 1, 12 combinations are present in Sets 1-4, with three items per set. The exemplary training sequence specifies set 1, then sets 2, 3, 4, in that order. In an example, once mastery of one subset is reached, teaching will continue for the next subset. In various aspects, responses will be considered correct if the learner responds to the correct action-object combination to any level of assistance via prompts. A response will be counted as incorrect if the learner fails to make a response or indicates incorrect symbols. Each action-object combination of a subset can be presented, e.g., three times in, e.g., a random order. There can be, e.g., three trials for each combination and a total of, e.g., nine trials for a subset that includes, e.g., three action-object combinations. In various aspects, the system 1500 (FIG. 15) receives data of a training sequence from an interventionist, e.g., via a “setup” screen or screens provided in an app implementing methods described herein. In various aspects, the app can adapt to the learner's speed of acquisition. If the learner starts out strong with needing less than 3 trials to master a particular combination, the processor 1586 can determine that fewer than three trials can be performed on later sets without losing effectiveness of teaching.

The mand-model procedure previously used in matrix training by Nigam et al. (2006) can be implemented if learners need additional prompts to activate the correct sequence. The mand-model procedure demands or requests a proper response from the child (e.g., “Tell me by activating the symbol”), and provides the child a proper model (e.g., Point to, “Ball”) if the child does not respond at all or gives an incomplete response (Rogers-Warren & Warren, 1980). Further details of additional prompting are discussed below. In various aspects, the criterion for learning a particular subset of action-object combinations during intervention will be two correct responses out of three for each item over two consecutive sessions. Once criterion is reached in a given subset, trials will be conducted and generalization to the remaining subsets and other untrained combinations will be assessed. After conducting generalization trials, instruction continues with the next subset.

“Generalization” refers to testing combinations not trained, e.g., the 24 combinations in Table 1 not included in Sets 1-4. A generalization trial can include performing steps 110, 115-130, 135. Untrained action and object combinations in a matrix can be provided without any correction or prompt. For example, after training Set 1 of Table 1, the untrained stimulus “drop ball” can be presented, in hopes that the learner will select the visual representations of the words for “drop” and “ball.”

In an example, the training sequence begins with the three combinations in Set 1. This is a 2×2 subset of the 6×6 matrix in Table 1. After the learner demonstrates a selected mastery level with respect to Set 1, the training sequence can be updated to include the non-tested combination in Set 1, namely drop+ball. The training sequence can also be extended to include additional sets. For example, adding Set 2 extends the matrix to 4×4. The words and stimuli in the training corpus, and their arrangement into sets or other portions of a training sequence, can be determined randomly or by a clinician. In various aspects, as the learner progresses, the training sequence can be expanded to include successively larger matrices. The training corpus or sequence can also be expanded to include additional dimensions, i.e., combinations of words from three or more categories. For example, after Set 1, a third category can be added (e.g., action+object+location, or agent+action+object), expanding the matrix from 2×2 to 2×2×2.

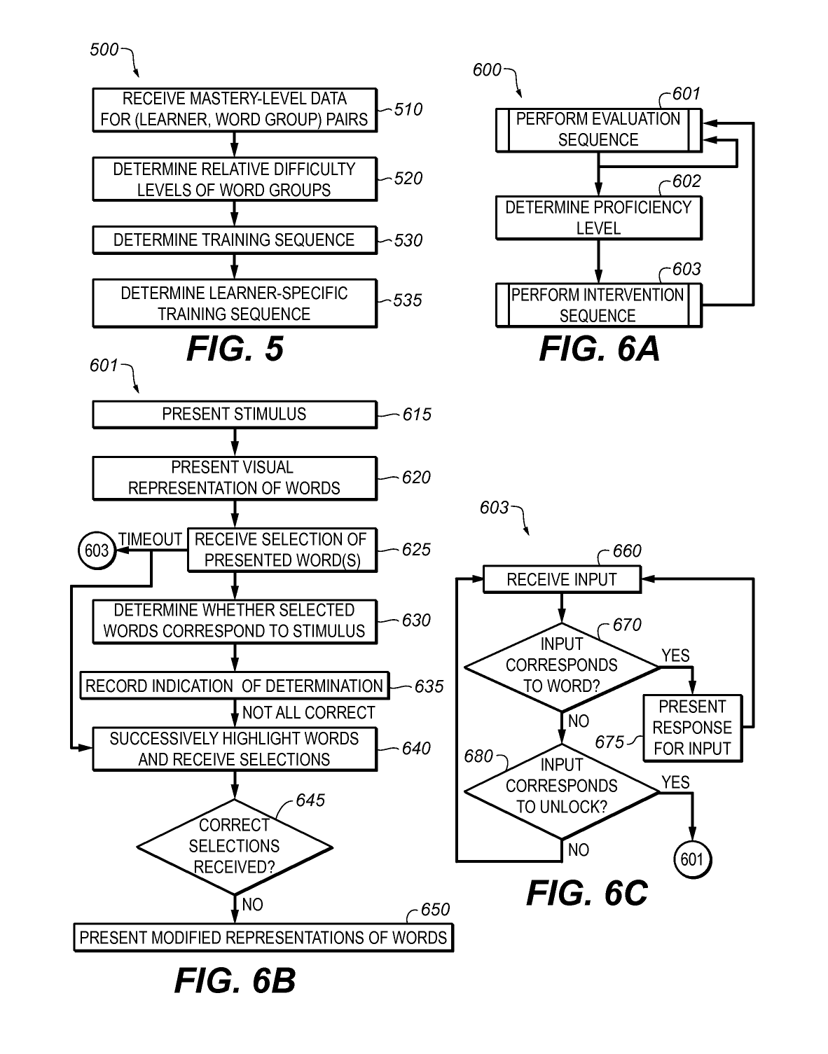

In various aspects, checking of answers for correctness, and tracking of those answers over long periods of time, is handled by processor 1586, FIG. 15, in an IPAD or other electronic device. This advantageously eases the heavy data-collection and -evaluation requirements of matrix training. In various aspects, the processor 1586 can predict or suggest changes in the number of repeats for each combination, e.g., as discussed below with reference to FIG. 2. This advantageously permits, e.g., determining when a learner has mastered a set of words and that learner's progress through the matrix can be accelerated, or determining whether all of the combinations in any given matrix need to be tested (for example, if the learner has learned drop with ball, cup, and fork, it may not be necessary to teach drop with spoon, apple, or car). This also advantageously permits adjusting the training sequence to focus on areas that need more training and improvement (e.g., perhaps the learner needs more work on “take out” than on “drop,” so combinations involving “take out” will be taught and tested more often or in greater number than combinations involving “drop”). Prediction and automation using techniques described herein can permit directing the flow of learning even without the involvement of a clinician to the levels required by conventional matrix training. This can expand the reach of training tools to learners who do not live in areas served by qualified medical personnel. In various aspects, the processor can suggest matrices to use based on a particular learner's mastery of previous matrices (see also FIG. 5, discussed below).

In step 145, a mastery level is determined using the recorded indications for some or all of the plurality of stimuli. The mastery level can be, e.g., the percentage of correct action-object combinations (“target forms”) during baseline, intervention, and generalization trials. The mastery level can indicate consistency of correspondence between stimulus and selection over time (an “accuracy score”). In various aspects, the mastery level is selected from the group consisting of an accuracy score, a time rate of completion (how long the learner takes to select the correct words after presentation of the stimulus), and a stimulus developmental level.

In various aspects, e.g., aspects in which a given stimulus is tested multiple times, step 145 determining a specific mastery level (as opposed to the “mastery level”) for the given stimulus using the recorded indications corresponding to the given stimulus. Uses of the specific mastery level are discussed below with reference to FIG. 2.

In step 150, the training corpus or the training sequence is modified based on the mastery level. This is discussed below with reference to FIG. 2.

In various aspects, step 130 or step 135 is followed by step 160. In step 160, feedback is provided responsive to the result of the determination via the electronic display or an output device. The feedback can be audible, visual, tactile, or other sensor modalities, individually or in any combination. Examples of feedback are discussed below.

FIG. 2 is a flowchart of modifying step 150 according to various aspects. As noted above, steps can be performed in any order unless expressly limited, and the methods shown are not limited to being performed by particular identified components. Step 150 includes decision step 210 of determining whether a selected mastery level has been reached.

To determine whether the mastery level has been reached, obtained data can be automatically graphed or plotted on the touchscreen 1120 or other electronic display, and the graph or plot can be visually inspected by a clinician for changes in level (mean) and trend. Visual analysis is regarded a very effective analytical technique in single-subject experiments (Kennedy, 2005). To evaluate the effects of various aspects, six features can be inspected for within- and between-phase data patterns: (1) level, (2) trend, (3) variability, (4) immediacy of the effect, (5) overlap, and (6) consistency of data patterns across similar phases. “Level” is an indicator for the mean score of the data within a phase. “Trend” means the slope of the best-fitting straight line for the data within a phase and “variability” denotes the range or standard deviation of data surrounding the best-fitting straight line. “Immediacy of effect” describes the change in level between the last three observations in one phase and the first three observations of the following phase. “Overlap” is an expression for the proportion of data from one phase that overlaps with data from the previous phase. The smaller the proportion of overlap, the more convincing is the demonstration of an effect. “Consistency of data patterns across similar phases” refers to the clinician eye-balling data from all phases within the same condition (e.g., all “baseline” phases) and determining the extent to which data patterns show consistency from phases with the same conditions. The more consistent data patterns are, the more likely is the representation of a causal relation.

These six aspects can be examined individually and collectively to assess whether obtained data for a particular learner demonstrate a causal relation. In various aspects, the processor 1586 can determine whether the recorded indications indicate at least three demonstrations of an effect at different points in time. Once this criterion is met, the indications can be considered to indicate a causal relation, and an inference can be drawn that generalized production of trained and untrained symbol combinations by that learner is causally related to the implementation of matrix training (Kratochwill et al., 2010).

Visual analysis can be supplemented by statistical analysis of changes in level and/or trend. The average (mean) of the data within a condition is the level and will be used to estimate the central tendency of the data. The split-middle technique will be applied to quantitatively estimate the trend. This technique splits the data points in half, creates a median for each half, and then intersects both medians with a plotted line (Kazdin, 1982).

In various aspects, within-learner replication is used across four sets of action-object combinations, so there will be four baseline-treatment phase comparisons per learner. The shift in performance from baseline to treatment can also be evaluated by applying a non-parametric procedure known as All Pair-wise Comparisons for Unequal Group Sample Sizes (Dunn, 1964). This technique statistically evaluates the degree of change across the four phase contrasts per learner. A non-parametric test is appropriate for this scenario because the distribution of single-subject data will be unknown (i.e., not normally distributed) and the data will not be independent. Furthermore, such a procedure automatically controls for the family-wise error rate which increases the likelihood of a Type I error when multiple tests are performed across several phase contrasts in one learner (Field & Miles, 2010). A SAS® or other macro can be used to make four key comparisons at an alpha level of 0.05 and to flag significant differences.

The extent of the intervention effects for each condition can be evaluated by calculating different effect size estimates for single-subject data. Currently available effect size metrics include non-parametric and regression-based procedures.

One of the most recent non-parametric effect size metrics for assessing data-overlap and estimating an effect size in single-subject data is the Non-overlap of All Pairs (NAP; Parker & Vannest, 2009), discussed below with reference to Table 3. In various aspects, processor 1586 can determine NAP values and present visual representations thereof to interventionists or learners (e.g., numeric readouts or red/yellow/green “stoplight” indicators).

Because non-parametric effect size methods do not consider trend in the data and their distributional properties are unknown, a regression-based estimate can be used (Kratochwill et al., 2010). Regression-based analysis for the data in various aspects will be achieved through application of the regression-model for single-subject data proposed by Maggin et al. (2011), e.g., using the processor 1586. This method applies Generalized Least Squares (GLS) to model the autocorrelation typically found in single-subject data (Matyas & Greenwood, 1996) and derive regression parameters to produce an effect size that indicates the magnitude of intervention effect from baseline to subsequent phases in standard deviation units.

The GLS effect size method is applicable to various aspects. According to Swaminathan et al. (2010) requirements include a minimum of 20 observations for each learner with no less than 5 observations in each phase, and various aspects meet these criteria.

In step 220, once the selected mastery level is reached, words and corresponding stimuli are automatically added to the training sequence. The selection of words can be predetermined, or can be dynamic and not necessarily only based on a predetermined matrix.

In an example using stimulus developmental level, the stimuli are classified according to developmental level. Once the words and combinations for a given developmental level are mastered, words and combinations for the next developmental level are introduced. E.g., once 2-3-year-old-appropriate matrix(ces) are mastered, 4-5-year-old-appropriate matrices can be used.

In various aspects, at least one of the added words is a word for which no pre-assessment has been performed. For example, new vocabulary can be added that is developmentally appropriate but that the learner has not seen. In an exemplary aspect, the 6×6 matrix of Table 1 is expanded to 7×7 or larger by adding new actions and objects, and the corresponding stimuli, to the training corpus. This can be particularly useful when the learner is at a developmental level between three and four years of age, at which level vocabulary generally grows exponentially for a period of time. In an example, known verbs are combined with new objects not in the learner's inventory. This permits determining whether the learner can match the, e.g., video stimulus to the combination of known and unknown stimuli, which can provide useful feedback on the learner's progress and generalization skill. In various aspects, new words are not automatically added, but a visual representation (e.g., a list) of possible new words is presented on a display for interventionist or clinician review and approval. The words can be selected from developmental inventories based on the age of the learner.

In step 230, once the selected mastery level is reached, words and corresponding stimuli are automatically added to the training corpus. For example, once 2-D matrices have been learned and a certain level of mastery has been reached, categories and corresponding words and stimuli can be added to the training corpus to move the learner 3-D, then 4-D, . . . matrices.

In step 240, once the selected mastery level is reached, each of the words included in a selected one of the categories is removed from the training sequence or the training corpus. Step 240 is followed by step 245. In general, whenever words or the stimuli are added to or removed from the training corpus, corresponding changes can be made to the stimuli or words, respectively.

In step 245, a plurality of words included in a selected additional category is automatically added to the training corpus and the training sequence. For example, the training matrix may become adaptive as the learner progresses, e.g., by substituting one category for another and leaving other categories the same. In an example, categories or words are substituted for other categories or words while the learner is proceeding through training. Depending on the learner's rate of progress as determined by the processor, it may be desirable to test every combination in a given matrix (e.g., all 36 entries of Table 1), or to skip some combinations if the learner shows mastery.

Step 250 can include adjusting a repeat count in the training sequence of a particular stimulus based on the specific mastery level for that stimulus. For example, fewer repetitions of certain combinations can be used for a learner exhibiting selected mastery levels. In an aspect, generalization trials are commenced sooner for learners who exhibit higher mastery levels than for learners who exhibit lower mastery levels.

Alternatively or additionally, step 250 can include modifying a number of repeats specified in the training sequence for each of a plurality of stimuli based on the determined mastery level. For example, fewer combinations can be tested, as noted above, for a learner exhibiting selected mastery levels.

FIG. 3 is a flowchart of ways of performing pre-assessment according to various aspects. As noted above, steps can be performed in any order unless expressly limited, and the methods shown are not limited to being performed by particular identified components.

Various aspects include pre-assessment and pre-training. In these aspects, a pre-assessment will be conducted to ensure that the learners know the meanings of the individual symbols to be combined (e.g., 6 actions and 6 objects). To assess receptive knowledge, learners will be provided a single-word stimulus, e.g., will be asked the question “Show me . . . ” and will be expected to activate the visual representation on the screen of the word presented in the stimulus. For expressive knowledge of actions, a video clip will show an action and the question “What is (character/caretaker/trainer) doing?” will be asked, e.g., via a text or audio prompt. Learners will be expected to point to the corresponding visual representation. For expressive knowledge of objects, the screen will show the objects and the question “What is this?” will appear. Again, learners will be expected to point to the appropriate visual representation. No feedback will be provided. The (e.g.) six actions and six objects will be tested in random order four times across 48 trials. The criterion for determining that a learner knows an action or object receptively or expressively will be two correct responses out of four trials (as an example). If necessary, additional pre-training will be provided to ensure receptive and expressive knowledge of all 6 objects and 6 actions. Pre-assessment can advantageously use the electronic features of a tablet or other computer to show a wider range of types of single-word stimuli than can be shown on conventional communication boards, and to maintain the records required.

During a baseline phase according to various aspects, trials will be conducted for the, e.g., 36 action-object combinations. One action-object combination will be given to the learner in each trial. The screen will show an action with an object while asking open-ended questions (e.g., “What is Jeeves doing?” if the learner knows Jeeves). Only when the learner activates action and object symbols in correct sequence within (e.g.) 4 s is the response considered correct. The system will not correct wrong answers or provide any prompts.

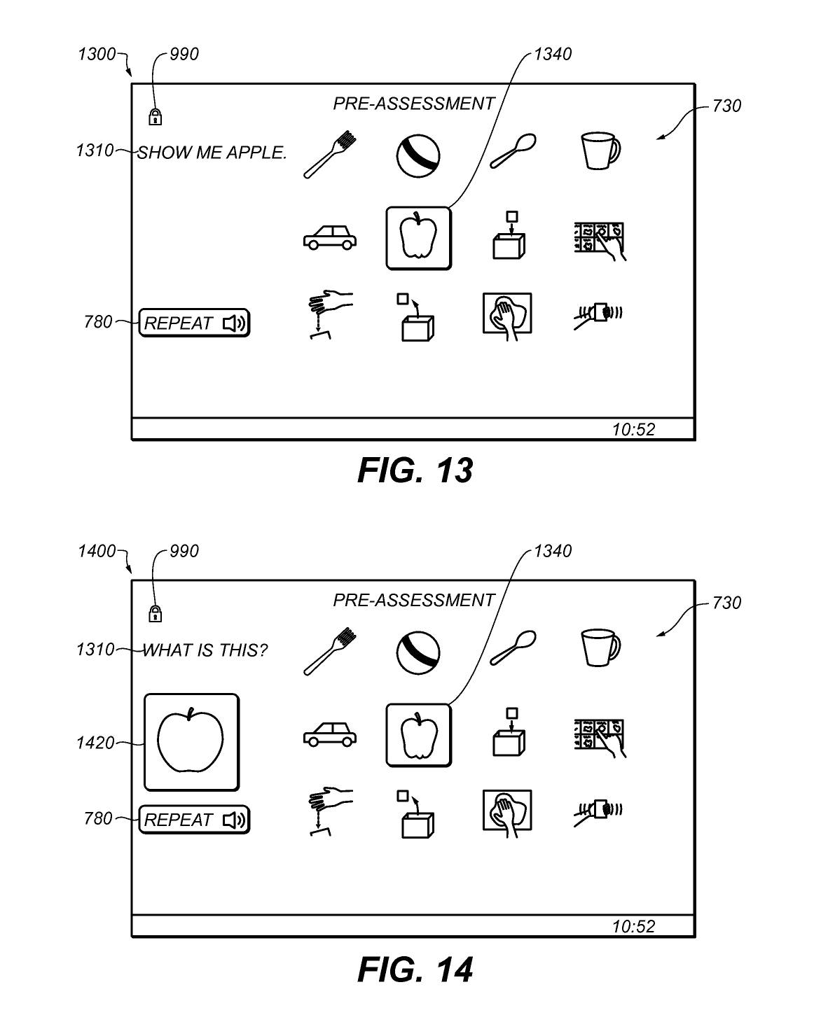

In step 310, a single-word stimulus representing one of the words is presented. The single-word stimulus can be, e.g., a text string or a graphic or video depicting the word. The term “single-word stimulus” does not signify that the stimulus itself is limited to a single word. Instead, that term signifies that the stimulus as a whole corresponds to only one of the words. Examples of single-word stimuli include text 1310 (FIG. 13) and graphic 1420 (FIG. 14).

In step 315, visual representations of at least some of the words are presented. An example is discussed below with reference to icons 730, FIGS. 13 and 14.

In step 320, a selection of exactly one of the at least some of the words is received via the input device. An example is icon 1340, FIG. 13.

In step 325, the processor automatically determines whether the selected word corresponds to the single-word stimulus.

Steps 315-325 can be repeated for same word or for each of a plurality of different words. A pre-assessment sequence can also include multiple interspersed repeats of a plurality of words (e.g., apple, apple, car, fork, cup, fork, shake, apple).

FIG. 4 is a flowchart of ways of conducting feedback step 160, FIG. 1, according to various aspects. As noted above, steps can be performed in any order unless expressly limited, and the methods shown are not limited to being performed by particular identified components. In these aspects, the providing-feedback step 160 includes, if the selected words do not correspond to the represented words in the stimulus, automatically performing at least some of the following steps, e.g., using a processor.

In step 410, the correct ones of the presented words on the display are successively highlighted. The processor waits to receive a selection of each of the correct ones of the presented words during the highlighting thereof. That is, in an example shown in FIG. 8, the processor successively displays a highlight on icon 741, the visual representation of the word “drop”; waits to receive a selection of icon 741 from the learner; displays icon 741 without highlight and displays icon 742 (“cup”) with highlight; and then waits to receive a selection of icon 742 from the learner. The waiting steps can include a timeout so that if no selection is received within a certain amount of time (e.g., 4 s), the learner is considered to have answered incorrectly.

In step 415, the processor automatically determines whether a selection of each highlighted word was received during the highlighting of that word. Steps 410 and 415 can be performed concurrently or sequentially. If not all the words were correctly received (“NOT ALL CORRECT”), step 415 can be followed by step 420.

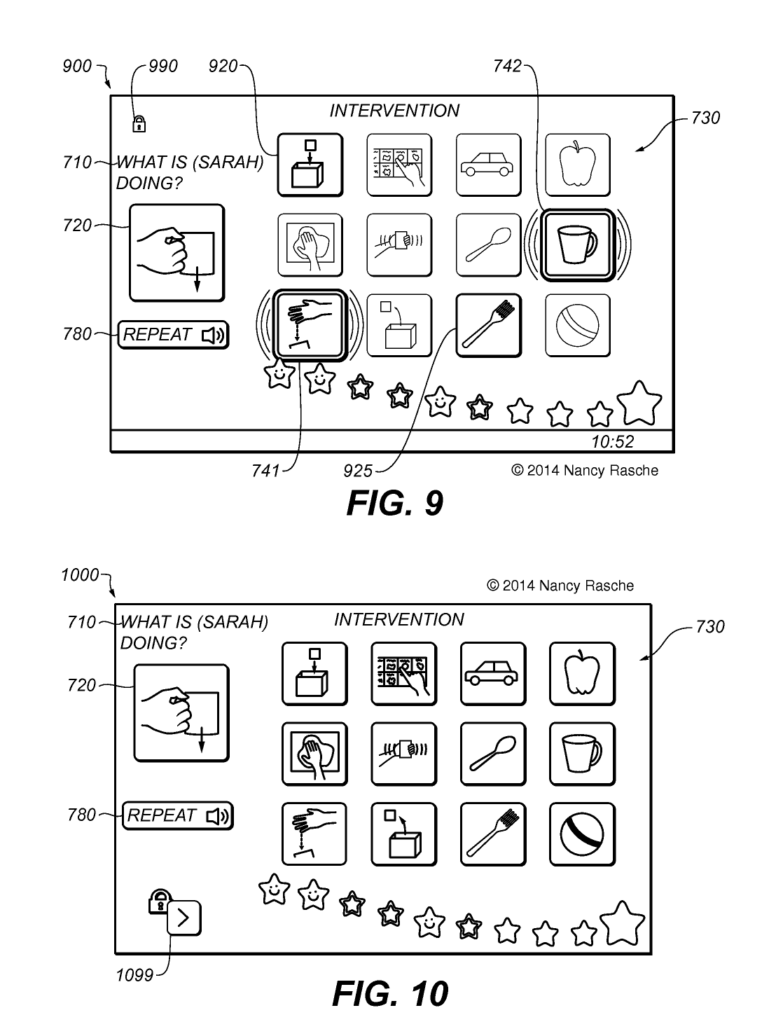

In step 420, if a selection of at least one of the highlighted words was not received during the highlighting of that word, the processor automatically presents modified visual representations of the plurality of the words via the display. In step 420, at least some of the words are not displayed or are displayed faded out or with reduced visibility. Examples are icons 730 other than icons 741, 742, 910, 920 shown in FIG. 9. This can advantageously reduce the probability of sensory or cognitive overload of the learner.

In step 425, selections of one or more of the presented words are received.

In step 430, the processor determines whether the received selections correspond to the represented words in the stimulus.

FIG. 5 is a flowchart of methods of conducting generative language training. As noted above, steps can be performed in any order unless expressly limited, and the methods shown are not limited to being performed by particular identified components. The method comprises automatically performing the following steps using a processor.

In step 510, respective mastery-level data are received for each of a plurality of learners and each of a plurality of groups of words. The respective mastery-level data indicating correspondence of selections from those words by that learner with stimuli presented via an electronic display. The mastery-level data can include mastery levels determined as discussed above, e.g., with reference to step 145, FIG. 1. The mastery-level data can be aggregated by, e.g., determining the mean, median, mode, range, standard deviation, or other characteristics of the data.

In step 520, using the processor, a respective relative difficulty level is automatically determined for each of the groups of words using the corresponding mastery-level data. In one example, words can be ranked by the average mastery level of each word across all learners, and the lowest average mastery level can correspond to the highest relative difficulty level. In various aspects, difficulty is linked to developmental level and the groups of words are targeted depending on the developmental language level a particular learner is at. Thus, e.g., agent-action, action-object, or modifier-object, can be presented before possessor-object, which can be presented before object-preposition and similar combinations, before moving to three-category combinations.

In another example, pre-assessment testing as described above with reference to FIG. 3 is executed to determine how many trials a learner needs until that learner shows mastery of a selected single word on the expressive and receptive language tasks. Some words the learner will get right on the first trial; for other word, more trials will be needed until a correct response is received. In some situations the interventionist may have to add a teaching trial to elicit the correct response. After pre-assessment, a data report can be produced by the processor 1586, FIG. 15, showing the words from each category alongside with the number of trials needed to mastery. Words with relatively lower numbers of trials are considered to be less difficult (e.g., concrete object such as “cup”) and words with relatively higher numbers of trials are considered to be more difficult (e.g., abstract action such as “point to”). The relative difficulty level of words with respect to a particular learner can thus be determined based on the number of pre-assessment trials required by that learner. The relative difficulty level can be determined for a group of learners by, e.g., adding or averaging the respective trial counts for each word across the population of learners.

In step 530, a training sequence for the groups of words is determined based on the determined relative difficulty levels. In an example, such a training sequence can follow a trajectory of proper language targets according to developmental age of the learner. Decisions how to group the words can be based on standardized child language assessment instruments (such as, for example, Preschool Language Scale, Rosetti Infant Toddler Language Scale, McArthur CDI, Reynell Developmental Language Scales). In another example, in determining which groups of words to teach in which order, and the order of words within those groups, relative difficulty level data, such as trial counts described above, can be used to select the order so that not all of the words at the very beginning of a trial are relatively difficult, and that sets are created of approximately equal difficulty (e.g., approximately equal distribution of easy and difficult words within a set). In various aspects, step 530 is followed by step 540.

In an example of step 530, certain concepts might be more familiar to a rural audience (hay bales, tractors) or an urban audience (skyscrapers, subways). Words with a high relative difficulty across an entire group (low value and low standard deviation of mastery level) can be removed from the training sequence and replaced with words for items or concepts more familiar to the particular group of learners being trained.

In another example of step 530, as more learners use, e.g., an app implementing methods described herein, the relative difficulty of sets of words can be evaluated across learners. The training sequence can then be adjusted for new learners beginning to use the app so that easier sets of words are presented before harder sets of words.

In step 540, a respective training sequence is determined for at least one of the plurality of learners using the determined relative difficulty levels and the mastery-level data corresponding to the at least one of the plurality of learners. In an example, the mastery-level data of a plurality of learners is compared to the relative mastery of one learner to produce an effective training sequence for the one learner. For example, if one learner has significantly higher mastery levels than the group, words of higher difficulty can be added to the training sequence for that particular learner. Other decisions can also be made using the relative mastery of one learner compared to a group of learners. In an example, if a learner is making very little to no progress on a set so that more and more sessions are needed, the average performance of the group could be used as a reference point to determine a recommended time at which to stop the language training of particular category(ies) or word(s). If, e.g., the group on average has mastered a particular set of words in x sessions, if the learner is beyond x+3 or x+5 sessions (the number 3, 5, or another choice, e.g., determined by a clinician) and not improving, the processor 1586 can display or transmit an indication to the interventionist or a clinician that the intervention should stop, in general or with respect to this particular set. This can indicate the learner has reached a boundary where further learning is impeded (e.g., by disability) and continued intervention may not produce any further benefit (and rather lead to, e.g., frustration or escape behavior).

FIGS. 6A-6C are a flowchart of ways of conducting generative language training using a training corpus having a plurality of words and a plurality of stimuli. The method can include automatically performing steps 601-603 using a processor. As noted above, steps can be performed in any order unless expressly limited, and the methods shown are not limited to being performed by particular identified components. Throughout steps 601-603, feedback can be provided to the learner, e.g., via audible or tactile stimulation.

In step 601, an evaluation sequence is performed one or more time(s) to determine respective indication(s). Various examples of the evaluation sequence are discussed below with reference to FIG. 6B.

In step 602, a proficiency level is automatically determined using the respective indication(s). Examples of proficiency level include but are not limited to: percent correct, percent in error, and number of consecutive correct or erroneous (“streak”). In various aspects, the proficiency level is selected from the group consisting of a number correct, a percentage correct, a number incorrect, a percentage incorrect, and an average elapsed time to respond correctly. In other aspects, the proficiency level is determined using a standardized language assessment instrument.

In step 603, if the determined proficiency level corresponds to an intervention criterion, performing an intervention sequence. This can be mathematically expressed as determining whether a predicate C(·), the intervention criterion, is satisfied by proficiency level p. Various examples of the intervention sequence are discussed below with reference to FIG. 6C. In various aspects, the intervention criterion is selected from the group consisting of less than a selected percentage X correct (C(p)=p<X), more than a selected percentage Y incorrect (C(p)=p>Y), less than a selected number Z correct (C(p)=p<Z), more than a selected number W incorrect (C(p)=p>W), and elapsed response time above a selected threshold T (C(p)=p>T).

Referring to FIG. 6B, the evaluation sequence according to various aspects includes various of the steps shown.

In step 615, a stimulus via an electronic display. The stimulus represents multiple ones of the words, and can include a visual animation or another type of presentation described herein.

In step 620, visual representations of a plurality of the words are presented via the display. Each word is included in at least one of a plurality of categories. Step 620 includes presenting the respective visual representations of one word included in a first one of the categories and one different word included in a second, different one of the categories.

In step 625, a selection of a plurality of the presented words is received via an input device. In various aspects, the input device is or includes a touch sensor arranged over the display in a touchscreen configuration. Step 625 can include determining whether the selection has been received within a selected timeout, and, if not, performing an intervention sequence (e.g., step 603, FIG. 6A), or performing modeling (e.g., step 640).

In step 630, the processor determines whether the selected words correspond to the represented words in the stimulus.

In step 635, the processor records the respective indication of the result of the determination. This can be done as discussed above with reference to step 135, FIG. 1. In various aspects, step 635 is followed by step 602, FIG. 6A. In various aspects, if not all the selected words correspond to the represented words in the stimulus (“NOT ALL CORRECT”), step 635 is followed by step 640.

In step 640, if the selected words do not correspond to the represented words in the stimulus, the processor automatically successively highlights the correct ones of the presented words on the display and waits to receive a selection of each of the correct ones of the presented words during the highlighting thereof. This can be done as described above with reference to FIG. 4.

In decision step 645, the processor determines whether the appropriate selections were received at the appropriate times, e.g., within a selected timeout. If not, an intervention sequence can be performed in step 650.

In step 650, if the appropriate selections were not received at the appropriate times, the processor automatically presents modified visual representations of the plurality of the words via the display. At least some of the words are not displayed or are displayed faded out or otherwise with reduced visibility, e.g., as discussed above with reference to FIG. 4. The receiving-selection and determining steps 640, 645 can then be repeated.

Referring to FIG. 6C, the intervention sequence according to various aspects includes various of the steps shown. An example of an intervention sequence according to various aspects is discussed below with reference to FIG. 10.

In step 660, an input is received. The input can be, e.g., a touch on a touchscreen, or another input herein. The input can be a selection of an icon 730, FIG. 7.

In decision step 670, the processor determines whether the input corresponds to one of the visual representations of the words. If so, the next step is step 675. If not, the next step is step 680.

In step 675, a response is presented via the electronic display or an output device (whether audible, visual, tactile, olfactory, or gustatory). The response can include, e.g., video highlighting of the selected icon 730, FIG. 10; playback of a sound waveform corresponding to the respective word via an audio output device; playback of a video; of vibration of a tablet or SGD. Step 675 is followed by step 660.

In decision step 680, the processor determines whether the input corresponds to an unlocking input. If not, the next step is step 660. If so, the next step is step 601, FIG. 6A. Upon return to step 601, in various aspects, a second, different stimulus is presented via the electronic display. In other aspects, the same stimulus is presented via the electronic display. In this way, evaluation and intervention sequences can be repeated for a given stimulus or multiple stimuli. The illustrated processes can repeat as long as the learner or interventionist desires.

FIG. 7 is a graphical representation of an exemplary screen display 700 of a system for conducting generative language training according to various aspects. Prompt 710 is a question, e.g., “What is Sarah doing?” that corresponds to stimulus 720. Prompt 710 can refer to a favorite character, caretaker, teacher, or other agent with which the learner is familiar (in this example, one named “Sarah”). Stimulus 720 illustrates a combination of two words from different categories. In this example, the categories are “action” and “object,” and stimulus 720 is a video of a cup (object) being dropped (action). When this screen display is shown, prompt 710 can be played back via a speaker or other audio output device. Icon 780 can be pressed or selected to cause the prompt to be replayed.

Icons 730 (“cards,” “buttons”) are visual representations of various words in the categories. In FIG. 7, icons 730 include icons for (left-to-right, top-to-bottom) “put in,” “point-to,” “car,” “apple,” “wipe,” “shake,” “spoon,” “cup,” “drop,” “take out,” “fork,” and “ball.” In this example, the icons are arranged so that the first and second columns (counting from the left) represent actions and the third and fourth columns represent objects. However, the icons can be arranged in any order. A learner can choose from the icons 730 by touching icons 730 on a touchscreen, or pointing to and clicking on icons 730 using a pointing device such as a joystick, trackball, or mouse.

Icons 741, 742 are those selected by the learner, in this example. These represent words selected by the learner. A correct response to stimulus 720 is for the learner to select icon 741 (“drop”), then to select icon 742 (“cup”). This response corresponds to stimulus 720. This example is for 2-D matrix training, in which only combinations from two categories are tested. In examples using 3-D (in general, n-D) matrix training, the learner can be prompted to select three (n) icons 730, e.g., “drop,” “green,” “cup” for action×color×object matrix training. The screen 700 can be locked (i.e., can refuse to recognize selections of icons 730) during an initial time period after display of screen 700. The video of stimulus 720 can play during the initial time period. During this or any other modeling sequence, if the learner selects the correct icons 741, 742, training can resume with the next stimulus 720. If the learner does not select the correct icons 741, 742, in the correct order and time limit, an audio recording of the phrase “try again!” can be played back, or another response (visible, audible, or otherwise) can be provided to encourage the learner to continue.

In various aspects, the training sequence includes ten stimuli 720. These can include ten different stimuli 720, or less than ten with some repeats (e.g., eight stimuli can be used once each and one stimulus can be used twice, consecutively or spaced apart in the training sequence). In other aspects, the training sequence includes nine stimuli 720. Progress indicator 750 is a graphical representation of the learner's progress through the training sequence. Happy-face icons 755 indicate questions answered correctly, i.e., stimuli 720 for which the learner selected the ones of the icons 730 corresponding to the stimulus 720. Filled icons 760 indicate questions not answered correctly by the learner, i.e., stimuli 720 for which the learner did not select the ones of the icons 730 corresponding to the stimulus 720 on the first opportunity. These can include questions for which the learner selected the correct answer during modeling, e.g., as discussed above with reference to FIGS. 6B-6C. Empty icons 765 indicate questions not yet answered. Large icon 770 is a reward icon. When the learner answers all questions in a particular set of stimuli correctly, the processor 1586 can animate icon 770, e.g., to flash, wiggle, or appear to pop in and out. Processor 1586 can also cause sounds to be played together with a motion of icon 770. When the learner answers a question correctly, the corresponding icon in progress indicator 750 can appear, optionally with animation. Audio or other responses (e.g., a voice saying “you are correct!”) can also be provided. When a response is incorrect (e.g., because the wrong icon 730 is selected first, the two correct icons 730 are selected in the wrong order, or the learner does not respond), various levels of modeling or intervention can be performed.

FIG. 8 is a graphical representation of an exemplary screen display 800 of a system for conducting generative language training according to various aspects. FIG. 8 shows an example of modeling according to step 640, discussed above with reference to FIG. 6B. Icon 741 is highlighted to indicate that the learner should select icon 741 first. After icon 741 is highlighted, if the learner selects icon 741 (e.g., before a timer expires), icon 742 is highlighted to indicate the learner should select icon 742. If the learner does not select the correct icons 730 in the correct order within any applicable timeout period, further modeling can be performed.

FIG. 9 is a graphical representation of an exemplary screen display 900 of a system for conducting generative language training according to various aspects. FIG. 9 shows an example of modeling according to step 650, discussed above with reference to FIG. 6B. Icons 730 are now presented faded out or otherwise with reduced visibility. The exceptions are the icons 741, 742 for the correct answer, and two distractor icons 920, 925. The icons 741, 742 can be animated successively to indicate to the learner the correct sequence. The animation can include a highlight and a wiggling motion (represented graphically by the curved marks next to icons 741, 742), or another visible sequence designed to attract the learner's attention. Audio of the corresponding word can be played back at the same time as the icon is highlighted. If the learner does not select the correct icons 741, 742 within any applicable timeout, an intervention sequence can be performed. Unlocking icon 990 can be activated (e.g., by touch and swipe) by an interventionist to exit the modeling at any time.

FIG. 10 is a graphical representation of an exemplary screen display 1000 of a system for conducting generative language training according to various aspects. FIG. 9 shows an example of intervention as discussed above with reference to FIG. 6C. Lock icon 1099 can be, e.g., pressed and swiped on a touchscreen to provide an unlocking input. Icons 730 can be pressed to provide an input to which the processor provides a response, e.g., audio of the word represented by that icon 730. In this way, an interventionist can guide the learner in selecting the correct words. When the correct words are selected, or when an unlocking input is provided, the next stimulus in the training sequence can be presented on a screen similar to that represented in FIG. 7.

FIG. 11 is a graphical representation of a learner interacting with a generative-learning training system 1110 according to various aspects. In this example, the system 1110 includes a tablet computer having a processor executing computer program instructions to carry out generative learning as described herein. The tablet has a touchscreen 1120 including an electronic display and a touch input device. Exemplary screens described herein, e.g., as represented in FIGS. 7-10 and 12-14, can be displayed on the touchscreen 1120.

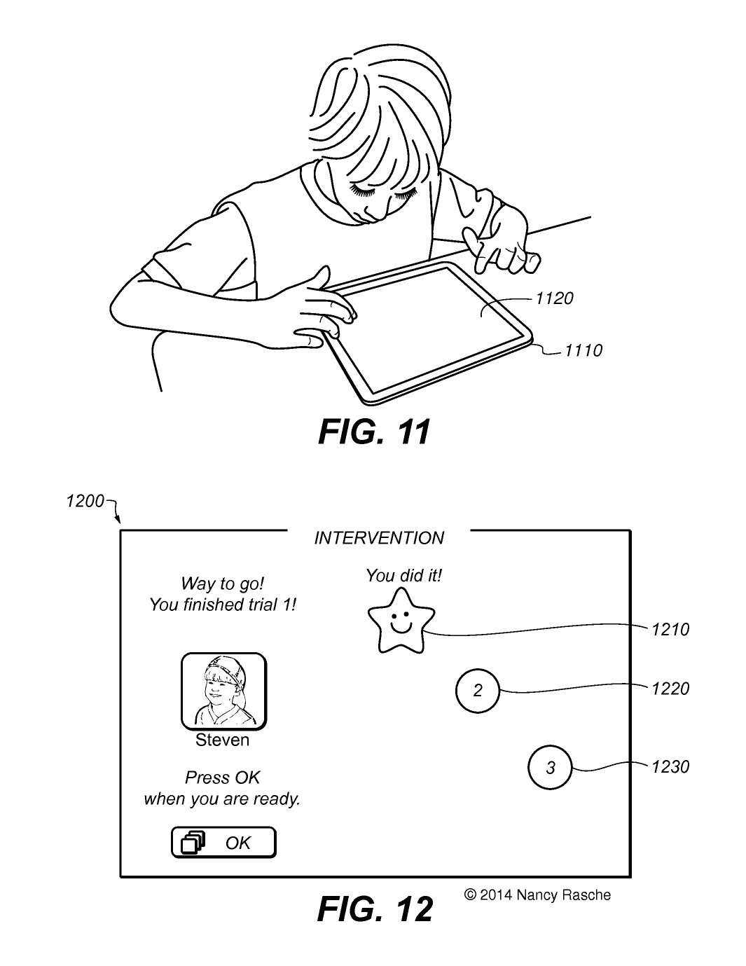

FIG. 12 is a graphical representation of an exemplary trial-progress screen display 1200 of a system for conducting generative language training according to various aspects. The training sequence can define one or more trials, each including one or more stimuli. At the end of each trial, e.g., after every nine stimuli, the trial-progress screen display 1200 can be shown. A picture of the learner or other decorative graphic can be displayed on screen 1200. Icon 1210 indicates that one trial is complete; icons 1220, 1230 indicate that there are two more trials to go. When all trials are complete, a large icon (not shown), e.g., an animated star happy face with the caption “YEAH, you did it!”, can be superimposed over the icons 1210, 1220, 1230.

FIG. 13 is a graphical representation of an exemplary screen display 1300 of a system for conducting generative language training according to various aspects. FIG. 13 shows an example of “receptive” pre-assessment as discussed above with reference to FIG. 3. In pre-assessment, no progress indicator is presented. Text 1310 is an example of a single-word stimulus. Audio corresponding to text 1310 can also be reproduced on initial display of screen 1300 or when repeat icon 780 is activated. In this example, no graphical or video stimulus is provided. Icons 730 include one icon 1340 corresponding to the single-word stimulus. In this example, a frame is shown around icon 1340, indicating icon 1340 is being selected or was selected. In other examples, frames are displayed around all of the icons 730. Displays similar to that shown can be successively presented for various single-word stimuli. In various embodiments, icons 730 are rearranged each time a new single-word stimulus is presented. In various aspects, if the learner does not select the icon 730 corresponding to the single-word stimulus on the first attempt, the next single-word stimulus is selected and a new screen 1300 presented.

FIG. 14 is a graphical representation of an exemplary screen display of a system for conducting generative language training according to various aspects. FIG. 14 shows an example of “expressive” pre-assessment as discussed above with reference to FIG. 3. In pre-assessment, no progress indicator is presented. Graphic 1420 is another example of a single-word stimulus, in this example presented accompanying text 1310. A video single-word stimulus (for actions) can also be used in place of graphic 1420 (for objects). A selection of icons 730 is presented. In various aspects, if the learner does not select the icon 1340 corresponding to the single-word stimulus on the first attempt, the next single-word stimulus is selected and a new screen 1400 presented. After a selected number of single-word stimuli have been presented, a happy-face star icon captioned “you did it!” can be superimposed over icons 730 and optionally animated.

In view of the foregoing, various aspects provide improved ways of facilitating generative language training of a learner. A technical effect is to present visual indications on a display screen of words and of a learner's progress. For example, mastery levels, specific mastery levels, and proficiency levels can be tracked over time. The resulting time series data can be displayed on an electronic display so that the interventionist can evaluate the learner's progress. Data for multiple learners, e.g., multi-trace time series or scatterplots, can also be displayed on an electronic display.

FIG. 15 is a high-level diagram showing the components of an exemplary data-processing system 1500 for analyzing data and performing other analyses described herein, and related components. The system 1500 includes a processor 1586, a peripheral system 1520, a user interface system 1530, and a data storage system 1540. The peripheral system 1520, the user interface system 1530 and the data storage system 1540 are communicatively connected to the processor 1586. Processor 1586 can be communicatively connected to network 1550 (shown in phantom), e.g., the Internet or a leased line, as discussed below. Data processing systems, e.g., tablet computers described herein, can each include one or more of systems 1586, 1520, 1530, 1540, and can each connect to one or more network(s) 1550. Processor 1586, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1586 can implement processes of various aspects described herein. Processor 1586 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1586 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1520, user interface system 1530, and data storage system 1540 are shown separately from the data processing system 1586 but can be stored completely or partially within the data processing system 1586.

The peripheral system 1520 can include one or more devices configured to provide digital content records to the processor 1586. For example, the peripheral system 1520 can include digital still cameras, digital video cameras, cellular phones, or other data processors. The processor 1586, upon receipt of digital content records from a device in the peripheral system 1520, can store such digital content records in the data storage system 1540.

The user interface system 1530 can include a mouse, a keyboard, another computer (connected, e.g., via a network or a null-modem cable), or any input device 1536 or combination of devices from which data is input to the processor 1586. The user interface system 1530 can also include a display device 1533, a processor-accessible memory, or any device or combination of devices to which data is output by the processor 1586. The user interface system 1530 and the data storage system 1540 can share a processor-accessible memory. The user interface system 1530 can permit communications between the system 1500 and a 1538.

In various aspects, processor 1586 includes or is connected to communication interface 1515 that is coupled via network link 1516 (shown in phantom) to network 1550. For example, communication interface 1515 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1515 sends and receives electrical, electromagnetic or optical signals that carry digital or analog data streams representing various types of information across network link 1516 to network 1550. Network link 1516 can be connected to network 1550 via a switch, gateway, hub, router, or other networking device.

In various examples, a second data-processing system 1501 is also connected to network 1550. The system 1501 can include components corresponding to those described herein for system 1500, e.g., processor 1586 and subsystems 1520, 1530, 1540. The system 1501 can communicate with a second user 1539. In an example, users 1538 and 1539 are learners and each system 1500, 1501 includes a tablet or other computer running an app or other computer program instructions operative to cause the respective processor 1586 in each system 1500, 1501 to conduct generative language training, e.g., as described above with reference to FIGS. 1-14. In another example, user 1538 is a learner and user 1537 is a therapist, parent, or other interventionist. Users 1537 and 1538 can interact together, sequentially or simultaneously, with system 1500, e.g., as described above with reference to FIG. 6C. An interventionist (not shown) can also assist user 1539 of system 1501. In an example, a server (not shown) can be connected to network 1550 and include a data-processing system similar to system 1500. The server can receive mastery-level data from systems 1500, 1501 and determine relative difficulty levels and perform other computations described above with reference to FIG. 5.

Processor 1586 can send messages and receive data, including program code, through network 1550, network link 1516 and communication interface 1515. For example, a server can store requested code for an application program (e.g., a JAVA applet) on a tangible non-volatile computer-readable storage medium to which it is connected. The server can retrieve the code from the medium and transmit it through network 1550 to communication interface 1515. The received code can be executed by processor 1586 as it is received, or stored in data storage system 1540 for later execution.

Data storage system 1540 can include or be communicatively connected with one or more processor-accessible memories configured to store information. The memories can be, e.g., within a chassis or as parts of a distributed system. The phrase “processor-accessible memory” is intended to include any data storage device to or from which processor 1586 can transfer data (using appropriate components of peripheral system 1520), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1540 can be a tangible non-transitory computer-readable storage medium, i.e., a non-transitory device or article of manufacture that participates in storing instructions that can be provided to processor 1586 for execution.

In an example, data storage system 1540 includes code memory 1541, e.g., a RAM, and disk 1543, e.g., a tangible computer-readable rotational storage device such as a hard drive. Computer program instructions are read into code memory 1541 from disk 1543. Processor 1586 then executes one or more sequences of the computer program instructions loaded into code memory 1541, as a result performing process steps described herein. In this way, processor 1586 carries out a computer implemented process. For example, steps of methods described herein, blocks of the flowchart illustrations or block diagrams herein, and combinations of those, can be implemented by computer program instructions. Code memory 1541 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1586 (and possibly also other processors), to cause functions, acts, or operational steps of various aspects herein, e.g., those discussed above with reference to FIGS. 1-6C, to be performed by the processor 1586 (or other processor). Computer program code for carrying out operations for various aspects described herein may be written in any combination of one or more programming language(s), and can be loaded from disk 1543 into code memory 1541 for execution. The program code may execute, e.g., entirely on processor 1586, partly on processor 1586 and partly on a remote computer connected to network 1550, or entirely on the remote computer.

A prototype IPAD app embodying methods of conducting generative language training as described herein was developed and was simulated on an Apple MacBook Retina laptop computer. Two learners, designated Learner D and Learner A, were tested with the app. Both were 12 year old males, diagnosed with severe autism according to the Autism Diagnostic Observation Schedule, 2nd edition (ADOS-2, Lord, Rutter, Pamela, DiLavore, Risi, Gotham, et al., 2012) and the Childhood Autism Rating Scale, 2nd edition (CARS2; Schopler, Bourgondien, Wellman, & Love, 2010). Learner D and Learner A tested as minimally verbal on a standardized language assessment (i.e., MacArthur CDI; Fenson, Marchman, Thal, Dale, Reznick, & Bates, 2007) and were using tablet computers for basic communication acts such as requesting and labeling.

Both learners were taught action-object symbol combinations on a 6×6 matrix as described above with reference to Table 1. The six actions included “point to”, “drop”, “take-out”, “put-in”, “shake”, and “wipe”; the six objects included “ball”, “cup”, “spoon”, “fork”, “apple”, and “car”. From the total pool of 36 possible symbol combinations, four different sets of three symbol combinations each were actively taught by an interventionist using the app. The remaining 24 combinations were tested for generalization effects.

Experimental sessions included a baseline phase followed by an intervention phase. During baseline, there was no training of combinations. Students were presented the 36 video stimuli as described above with reference to steps 310, 315 and asked to activate the correct combination of visual representations of words on the screen of the laptop. The intervention phase involved the active training of the four sets with all 12 combinations taught in sequence. After each intervention session generalization probes were conducted on the remaining 24 symbol combinations. Thus, two strands of data were created for each participant, one that shows the acquisition of the training sets (Table 2, “Intervention” data, below), and a second one that indicates generalization to the untrained combinations (Table 2, “Generalization” data, below).

The research design used was an experimental single-subject design: experimental control was established by repeatedly measuring performance over time within a research participant, and then the effect was replicated across another individual. Single subject research designs represent a rigorous approach to evaluating treatment efficacy and are preferable when research is challenged by vast heterogeneity within a population such as severe autism with no functional speech (Schlosser & Raghavendra, 2004).

Table 2 shows experimental data of the effectiveness of generative-language training systems described herein, specifically, participants' performance measured as the percentage of correct symbol combinations. Both participants demonstrated a similar pattern of successful acquisition of symbol combinations during the intervention condition and subsequent generalization to untrained stimuli. Visual analysis of the data indicated a flat baseline of zero percent correct symbol combinations before training started. Within three intervention sessions, both Learner D and Learner A reached a mastery level of over 80% correct and their performance remained at this level over repeated tests. Performance on generalization increased steadily for both participants over the course of intervention and also plateaued at the same mastery level.

TABLE 2
Single-subject research results for effects of
matrix training on correct symbol combinations.

| | |
|---|---|
| Intervention | Generalization |

| | | | |
|---|---|---|---|
| Date | % correct | Date | % correct |

Learner D

| | | | | |
|---|---|---|---|---|
| Baseline | 5/5 (1) | 0.00% | 5/5 (1) | 0 |
| | 5/5 (2) | 0.00% | 5/5 (2) | 0 |
| | 5/7 (1) | 0.00% | 5/7 (1) | 0 |
| Set 1 | 5/7 (2) | 0.00% | 5/7 (2) | 0 |
| | 5/7 (3) | 44.00% | 5/12 (1) | 83% |
| | 5/12 (1) | 100.00% | 5/12 (2) | 92% |
| | 5/12 (2) | 100.00% | 5/12 (3) | 92% |
| | 5/14 (1) | 100.00% | 5/14 (1) | 97% |
| | 5/14 (2) | 100.00% | 5/14 (2) | 92% |

Learner A

| | | | | |
|---|---|---|---|---|
| Baseline | 5/6 (1) | 0% | 5/6 (1) | 0% |
| | 5/6 (2) | 0% | 5/6 (2) | 0% |
| | 5/9 (1) | 0% | 5/9 (1) | 0% |
| Set 1 | 5/9 (2) | 33% | 5/9 (2) | 33% |
| | 5/9 (3) | 56% | 5/9 (3) | 89% |
| | 5/13 (1) | 89% | 5/13 (1) | 89% |
| | 5/13 (2) | 100% | 5/13 (2) | 86% |
| | 5/15 (1) | 100% | 5/15 (1) | 69% |
| | 5/15 (2) | 100% | 5/15 (2) | 83% |

The extent of the intervention effects for each participant was quantified by calculating effect size estimates for single-subject data. Effect size is an indicator of the magnitude of change or difference between baseline to intervention conditions (Beeson & Robey, 2006). One of the most recent effect size metrics for assessing effect size in single-subject data is the Non-overlap of All Pairs index (NAP; Parker & Vannest, 2009). NAP is obtained through the sum of overlap of all possible paired data comparisons between baseline and subsequent intervention phases. This yields a percentage score indicating the amount of change. A score from, e.g., 0-65% indicates weak effects, 66%-92% indicates medium effects, and 93%-100% indicates large or strong effects (Parker & Vannest, 2009). Effect sizes for the learners were determined; the values are given in Table 3.

TABLE 3

| Participant | Intervention NAP | Generalization NAP |
|---|---|---|
| Learner D | 92% (medium-strong effect) | 92% (medium-strong effect) |
| Learner A | 100% (strong effect) | 100% (strong effect) |

These results indicate that the matrix training intervention implemented via the IPAD app created an effect large enough to help the participants acquire action-object symbol combinations and generalize to new combinations not previously taught.

In various aspects, generative training methods and systems as described herein are used in contexts other than various language training embodiments described above. Several examples are given below. The description above applies for each of these examples, with suitable changes as indicated in each example.

In an example, techniques herein are used for training of pre-literacy skills. Many children with developmental delays or disorders show difficulty in basic readiness for literacy instruction, e.g., they have trouble following instructions to complete a worksheet. Instruction-following can be taught by setting up a matrix of one category including basic steps (e.g., circle, cross-out, put a “1” on . . . etc.) versus one category of known objects (e.g., ball, apple, car, etc.). This permits training the general completion of tasks (Axe & Sainato, 2010). This is an application of generative instruction, that is, a limited set of instructions is actively taught, and generalization is facilitated, so that new instruction-following skills emerge.

In another example, techniques herein are used for training of early literacy skills. A training matrix can be created with one category of elements being a within-word unit (singular or plural form, e.g., as indicated by plural morpheme /s/) and the other category being familiar or unfamiliar words. After training several singular and plural labels, generalized responses should emerge as untrained combinations of words with the morpheme /s/. Similarly, a matrix can be constructed to teach combinations of within-syllable units (i.e., onsets and rhymes). In such an arrangement, one category of onsets (e.g., “sop” or “sug”) would be combined with another category of rhymes (e.g., “sat” or “mat”) and new, generalized responses should occur as rearrangements of these units (e.g., “mop” or “mug”) (Mueller, Olmi, & Saunders, 2000).

In still another example, techniques herein are used for training of literacy skills (spelling): another application of the described procedures is teaching generative spelling to children with special needs. In this context, the task for the learner would be to combine a first category of beginning consonant sounds and a second category of word endings, e.g., sounds and endings known individually to the learner. The generalization component would be to spell new words that have not been taught before (e.g., learner would combine “c” with “up” to generate “cup”). (Kinney, Vedora, & Strohmer, 2003).

In yet another example, techniques herein are used for training of play skills. A common goal for children on the autism spectrum is the acquisition of proper play skills, as many of these individuals typically display physical manipulation of objects rather than functional and symbolic play. Generative play refers to the ability to extend current play skill repertoires to instances of playing with toys and objects in new and novel ways. A learner may know some toys (first category) such robot, car, and truck, and some activities or actions (second category) that can be performed with a toy such as “it goes fast/slows down”, “it crashes”, “it flies” etc. Novel play performances arise when previously taught toys and corresponding scripts are combined in new ways not explicitly taught before.

In a further example, techniques herein are used for training of social skills. A core deficit of children with autism spectrum disorders is an impairment in social-communicative skills. If at all, many of these individuals have a limited set of conventional social repertoires and scripts that may be used only with a limited number of individuals. In the sense of generative social skills training, a learner would be asked to extend previously taught social skills (first category; e.g., “say hello”, “say goodbye”, “look in the eyes”, “shake hands”, etc.) to new contexts (second category, e.g., contexts including new people or settings). This can permit training the learner to no longer perform the social skill only with mom or dad, but also with peers, teachers, or therapists, during a variety of daily activities).

In various aspects, a method of conducting generative language training includes a determining-and-recording step that includes determining whether the selection includes exactly one word included in a first category and exactly one word included in a second category. In various aspects, a method of conducting generative language training includes determining a mastery level that indicates consistency of correspondence between stimulus and word selection over time. In various aspects, a method of conducting generative language training includes, once a selected mastery level is reached, automatically adding words and corresponding stimuli to the training sequence, wherein at least one of the added words is a word for which no pre-assessment has been performed. In various aspects, a method of conducting generative language training includes repeating the presenting-stimulus through determining-and-recording steps for a selected one of the stimuli. In various aspects, a method of conducting generative language training includes modifying a number of repeats specified in the training sequence for each of the plurality of stimuli based on a determined mastery level. In various aspects, a method of conducting generative language training includes determining whether the selected words correspond to the represented words in the stimulus and providing feedback responsive to the result of the determination via the electronic display or an output device. In various aspects, a method of conducting generative language training includes presenting responses to inputs corresponding to visual representations of words, and the response includes a sound waveform presented via an audio output device, the sound waveform corresponding to the one of the visual representations corresponding to the input. In various aspects, a method of conducting generative language training includes receiving a selection of a visual representation of a word and the receiving-selection step further includes determining whether the selection has been received within a selected timeout, and, if not, performing an intervention sequence. In various aspects, a method of conducting generative language training includes determining whether selected words correspond to represented words in a stimulus, recording respective indications of the results of the determinations, and determining a proficiency level using the respective indication(s) for the stimuli. The proficiency level can be selected from the group consisting of a number correct, a percentage correct, a number incorrect, a percentage incorrect, and an average elapsed time to respond correctly. In this and other aspects, the stimulus can include a visual animation.

The invention is inclusive of combinations of the aspects described herein. References to “a particular aspect” (or “embodiment” or “version”) and the like refer to features that are present in at least one aspect of the invention. Separate references to “an aspect” or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method of conducting generative language training, the method comprising automatically performing the following steps using a processor:
receiving respective mastery-level data for each of a plurality of learners and each of a plurality of groups of words, the respective mastery-level data indicating correspondence of selections from those words by that learner with stimuli presented via an electronic display;
using the processor, automatically determining a respective relative difficulty level for each of the groups of words using the corresponding mastery-level data; and
determining a training sequence for the groups of words based on the determined relative difficulty levels.

15. The method according to claim 14, wherein the determining-sequence step further includes determining a respective training sequence for at least one of the plurality of learners using the determined relative difficulty levels and the mastery-level data corresponding to the at least one of the plurality of learners.

16. A method of conducting generative language training using a training corpus having a plurality of words and a plurality of stimuli, the method comprising automatically performing the following steps using a processor:
performing an evaluation sequence one or more time(s) to determine respective indication(s), the evaluation sequence including:
presenting a stimulus via an electronic display, the stimulus representing multiple ones of the words;
presenting visual representations of a plurality of the words via the display, wherein each word is included in at least one of a plurality of categories and the presenting includes presenting the respective visual representations of one word included in a first one of the categories and one different word included in a second, different one of the categories;
receiving a selection of a plurality of the presented words via an input device;
determining whether the selected words correspond to the represented words in the stimulus and recording the respective indication of the result of the determination;
determining a proficiency level using the respective indication(s);
if the determined proficiency level corresponds to an intervention criterion, performing an intervention sequence including:
receiving an input;
if the input corresponds to one of the visual representations, presenting a response via the electronic display or an output device, and returning to the receiving-input step; and
if the input corresponds to an unlocking input, presenting a second, different stimulus via the electronic display.

17. The method according to claim 16, wherein the evaluation sequence includes, if the selected words do not correspond to the represented words in the stimulus, automatically:
successively highlighting the correct ones of the presented words on the display and waiting to receive a selection of each of the correct ones of the presented words during the highlighting thereof; and
determining whether the appropriate selections were received at the appropriate times.

18. The method according to claim 17, wherein the evaluation sequence includes, if the appropriate selections were not received at the appropriate times, automatically presenting modified visual representations of the plurality of the words via the display, wherein at least some of the words are not displayed or are displayed faded out or otherwise with reduced visibility, and repeating the receiving-selection and determining steps.

19. The method according to claim 16, wherein the intervention criterion is selected from the group consisting of less than a selected percentage correct, more than a selected percentage incorrect, less than a selected number correct, more than a selected number incorrect, and elapsed response time above a selected threshold.

20. The method according to claim 16, wherein the input device includes a touch sensor arranged over the display in a touchscreen configuration.

21. The method according to claim 16, wherein the stimulus comprises a visual animation.

22. The method according to claim 16, further comprising, using the processor:
receiving respective mastery-level data for each of a plurality of groups of words, the respective mastery-level data indicating correspondence of selections from those words by two or more learners with stimuli presented via an electronic display;
determining a respective relative difficulty level for each of the groups of words using the corresponding mastery-level data;
determining a training sequence for the groups of words based on the determined respective relative difficulty levels; and
determining the stimulus based at least in part on the training sequence.

23. The method according to claim 22, wherein the determining-training-sequence step further includes determining a first training sequence for a first learner of the two or more learners using the determined relative difficulty levels and using a subset of the mastery-level data corresponding to the first learner.

24. The method according to claim 16, wherein:
the evaluation sequence comprises selecting the stimulus based at least in part on a predetermined training sequence; and
the method comprises, by the processor:
determining a mastery level using the recorded indications for the plurality of stimuli; and
modifying at least one of the training corpus and the training sequence based at least in part on the mastery level.

25. The method according to claim 24, wherein the modifying comprises:
determining that the mastery level is at least a predetermined mastery level; and
in response, adding words and corresponding stimuli to the at least one of the training corpus and the training sequence.

26. The method according to claim 24, wherein the mastery level is selected from the group consisting of an accuracy score, a time rate of completion, and a stimulus developmental level.

27. The method according to claim 16, further comprising, before presenting the stimulus:
presenting a single-word stimulus representing one of the words;
presenting visual representations of at least some of the words;
receiving a selection of exactly one of the at least some of the words via the input device, and
determining whether the selected word corresponds to the single-word stimulus.

28. A method of conducting generative language training using a training corpus having a plurality of words, the method comprising performing the following operations using a processor:
presenting, via an electronic display, a first stimulus representing a first set of words of the plurality of words;
presenting, via the electronic display, a first visual representation of a first word of the plurality of words, the first word included in a first category of a plurality of categories;
presenting, via the electronic display, a second visual representation of a second, different word of the plurality of words, the second word included in a second, different category of the plurality of categories;
presenting, via the electronic display, a third visual representation of a third word of the plurality of words, the third word different from the first word and the second word;
determining, after presenting the first stimulus and the first, second, and third visual representations, that a selection was not received via an input device within a selected timeout;
in response, presenting a modified visual representation of at least one of the first word, the second word, or the third word via the display, wherein the modified visual representation has reduced visibility compared with the respective one of the first visual representation, the second visual representation, and the third visual representation;
receiving, after presenting the modified visual representation, a selection of a second set of words of the plurality of words via the input device, the second set of words comprising at least two words presented via the electronic display;
making a determination of whether the second set of words corresponds to the first set of words; and
recording an indication of the result of the determination.

29. The method according to claim 28, further comprising:
determining a proficiency level based at least in part on the recorded indication;
determining that the determined proficiency level corresponds to an intervention criterion; and
in response, performing an intervention sequence including:
receiving an input via the input device; and
if the input corresponds to at least one of the first visual representation, the second visual representation, or the third visual representation, presenting a response via the electronic display or an output device, and returning to the receiving-input step.

30. The method according to claim 29, the intervention sequence further comprising, if the input corresponds to an unlocking input, presenting a second, different stimulus via the electronic display.

31. The method according to claim 28, wherein the stimulus comprises a visual animation.

32. The method according to claim 28, wherein:
the evaluation sequence comprises selecting the stimulus based at least in part on a predetermined training sequence; and
the method comprises, by the processor:
determining a mastery level using the recorded indications for the plurality of stimuli; and
modifying at least one of the training corpus and the training sequence based at least in part on the mastery level.

33. The method according to claim 28, further comprising, before presenting the stimulus:
presenting a single-word stimulus representing one of the words;
presenting visual representations of at least some of the words;
receiving a selection of exactly one of the at least some of the words via the input device, and
determining whether the selected word corresponds to the single-word stimulus.
